(19) United States
(12) Patent Application Publication
(10) Pub. No.: US 2018/0053234 A1
(43) Pub. Date: Feb. 22, 2018

(54) DESCRIPTION INFORMATION GENERATION AND PRESENTATION SYSTEMS, METHODS, AND DEVICES

(71) Applicant: Alibaba Group Holding Limited, Grand Cayman (KY)

(72) Inventors: Changlong Sun, Hangzhou (CN); Qiu Long, Hangzhou (CN); Jun Lang, Hangzhou (CN)

(73) Assignee: Alibaba Group Holding Limited

(21) Appl. No.: 15/677,973

(22) Filed: Aug. 15, 2017

(30) Foreign Application Priority Data
Aug. 16, 2016 (CN) 201610674634.4

(51) Int. Cl. G06Q 30/06; G06N 7/00

(52) U.S. Cl. CPC G06Q 30/0627; G06N 7/00

(57) ABSTRACT

The present application provides methods, systems, and electronic devices for generating and presenting data object description information. The generation method includes: obtaining an evaluation information set of a data object; extracting at least one current feature word set and at least one current sentiment word set from the evaluation information set; determining a representative feature word of each current feature word set respectively; determining a representative sentiment word corresponding to each representative feature word respectively according to a sentiment word associated with a feature word in each current feature word set; and generating description information based on at least one representative feature word and a respective corresponding representative sentiment word. Data object description information generation and presentation systems, presentation and generation methods, and electronic devices provided in example embodiments of the present application can improve the accuracy of data object description.

### CROSS REFERENCE TO RELATED PATENT APPLICATIONS

This application claims priority to Chinese Patent Application No. 201610674634.4, filed on Aug. 16, 2016, entitled “Description Information Presentation Systems, Methods, and Devices,” which is hereby incorporated by reference in its entirety.

### TECHNICAL FIELD

The present application relates to the field of information processing technologies, and in particular, to methods, systems, and devices for presenting and generating description information.

### BACKGROUND

With continuous development of network communication technologies, more online shopping applications are developed. In an online shopping application, evaluation information of a data object is generally provided by users. The evaluation information of the data object is generally entered by a user who purchases the data object, to express the user's opinion about the data object.

Generally, there is numerous evaluation information of the data object, and for a new user who wants to purchase the data object, it may take a lot of time to traverse every piece of evaluation information.

The description information of the data object in existing technologies is generally presented by using labels and counts. Specifically, multiple labels related to the data object may be preset, and these labels may be, for example, a series of phrases such as “good quality”, “good service attitude”, “cheap price”, and “slow logistics”. These preset labels may be stored in a background business server of the application. When the description information of the data object is generated, the background business server may obtain a preset quantity of evaluation information of the data object, and then conduct statistics on the number of times the preset labels appear in the evaluation information. For example, the background business server obtains totally 10 pieces of evaluation information of the data object. In the 10 pieces of evaluation information, 6 pieces of them mention that the service attitude of the seller is good, 8 pieces of them mention that the quality of the data object is good, and therefore, it may be obtained through statistics that the number of times corresponding to the label “good quality” is 8, and the number of times corresponding to the label “good service attitude” is 6. After the number of times corresponding to each label is obtained through statistics, the statistical number of times may be displayed in parentheses behind the label, for example, “good quality (8)”, and “good service attitude (6)”. In this way, the label having the statistical number of times displayed may be used as the description information of the data object, and is displayed above a comment area of the data object for users to view.

However, description information of data objects provided in a website mostly employ a label and counting method for presentation, and is limited to the data processing method of the website, the provided description information of the data objects is usually over-generalized, and there are few detail descriptions about the data object. For example, for a product “one-piece dress”, description information thereof merely mentions information such as good quality, good service attitude, and fast logistics, and does not describe details of the one-piece dress (for example, how the collar is designed, and to which figure the waistline suits). Therefore, the description information of the data object does not describe the data object accurately enough, and cannot provide more meaningful purchasing basis for users.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present application.

The present application provides a description information presentation and presentation system, presentation and generation methods, and electronic devices, which can improve the accuracy of data object description.

To achieve the above objective, one aspect of the present application provides a data object description information presentation system, the system including: a server and a client terminal, wherein steps performed by the server include: obtaining an evaluation information set of the data object, the evaluation information set including at least one piece of evaluation information; extracting at least one current feature word set and at least one current sentiment word set from the evaluation information set, wherein the current feature word set includes at least one feature word, the current sentiment word set includes at least one sentiment word, and each said feature word is capable of being associated with at least one sentiment word; determining a representative feature word of each said current feature word set respectively; determining a representative sentiment word corresponding to each said representative feature word respectively according to a sentiment word associated with a feature word in each said current feature word set; generating description information based on at least one representative feature word and a respective corresponding representative sentiment word; and sending the description information to the client terminal; and a step performed by the client terminal includes: presenting the description information.

To achieve the above objective, another aspect of the present application provides a data object description information generation method, the method including: obtaining an evaluation information set of the data object, the evaluation information set including at least one piece of evaluation information; extracting at least one current feature word set and at least one current sentiment word set from the evaluation information set, wherein the current feature word set includes at least one feature word, the current sentiment word set includes at least one sentiment word, and each said feature word is capable of being associated with at least one sentiment word; determining a representative feature word of each said current feature word set respectively; determining a representative sentiment word corresponding to each said representative feature word respectively according to a sentiment word associated with a feature word in each said current feature word set; and generating description information based on at least one representative feature word and a respective corresponding representative sentiment word.

To achieve the above objective, another aspect of the present application provides an electronic device, including: a memory configured to store an evaluation information set of a data object, the evaluation information set including at least one piece of evaluation information; and a processor configured to extract at least one current feature word set and at least one current sentiment word set from the evaluation information set, wherein the current feature word set includes at least one feature word, the current sentiment word set includes at least one sentiment word, and each said feature word is capable of being associated with at least one sentiment word; determine a representative feature word of each said current feature word set respectively; determine a representative sentiment word corresponding to each said representative feature word respectively according to a sentiment word associated with a feature word in each said current feature word set; and generate description information based on at least one representative feature word and a respective corresponding representative sentiment word.

To achieve the above objective, another aspect of the present application provides an electronic device, including: a memory configured to store an evaluation information set of a data object, the evaluation information set including at least one piece of evaluation information; a network communication module configured to conduct network data communication; and a processor configured to extract at least one current feature word set and at least one current sentiment word set from the evaluation information set, wherein the current feature word set includes at least one feature word, the current sentiment word set includes at least one sentiment word, and each said feature word is capable of being associated with at least one sentiment word; determine a representative feature word of each said current feature word set respectively; determine a representative sentiment word corresponding to each said representative feature word respectively according to a sentiment word associated with a feature word in each said current feature word set; generate description information based on at least one representative feature word and a respective corresponding representative sentiment word; and control the network communication module to send the description information.

To achieve the above objective, another aspect of the present application provides a data object description information generation method, the method including: presenting, by a client terminal, a page provided by a server, wherein the page includes a data object, an evaluation information set for the data object, and description information generated based on the evaluation information, and the evaluation information set includes at least one piece of evaluation information; wherein the description information is generated by the server in the following manner: extracting at least one current feature word set and at least one current sentiment word set from the evaluation information set, wherein the current feature word set includes at least one feature word, the current sentiment word set includes at least one sentiment word, and each said feature word is capable of being associated with at least one sentiment word; determining a representative feature word of each said feature word respectively; determining a representative sentiment word corresponding to each said current feature word set respectively according to a sentiment word associated with a feature word in each said feature word set; and generating description information based on at least one representative feature word and a respective corresponding representative sentiment word.

To achieve the above objective, another aspect of the present application provides a data object description information generation method, the method including: extracting a representative word of a feature of a data object from evaluation information of the data object; and generating description information based on the representative word and an obtained sentiment word.

To achieve the above objective, another aspect of the present application provides an electronic device, including: a memory configured to store evaluation information of a data object; and a processor configured to read the evaluation information of the data object from the memory, and extract a representative word of a feature of the data object from the evaluation information; and generate description information based on the representative word and an obtained sentiment word.

To achieve the above objective, another aspect of the present application provides a data object description information generation method, the method including: obtaining an evaluation information set of the data object, wherein the evaluation information set includes at least one piece of evaluation information; extracting at least one feature phrase from the evaluation information set; and generating description information based on the feature phrase, wherein the description information includes at least one paragraph.

To achieve the above objective, another aspect of the present application provides an electronic device, including: a memory configured to store an evaluation information set of a data object, wherein the evaluation information set includes at least one piece of evaluation information; and a processor configured to read the evaluation information set from the memory, and extract at least one feature phrase from the evaluation information set; and generate description information based on the feature phrase, wherein the description information includes at least one paragraph.

To achieve the above objective, another aspect of the present application provides a data object description information presentation method, including: sending a page access request of the data object to a preset URL; receiving feedback page data, wherein the page data includes an evaluation information set and description information of the data object, the description information is generated based on the evaluation information set, and the description information includes at least one paragraph; and presenting the page data.

To achieve the above objective, another aspect of the present application provides an electronic device, including: a network communication module configured to conduct network data communication; a processor configured to control the network communication module to send a page access request of a data object to a preset URL, and control the network communication module to receive feedback page data, wherein the page data includes an evaluation information set and description information of the data object, the description information is generated based on the evaluation information set, and the description information includes at least one paragraph; and a display screen configured to present the page data.

It can be seen from the technical solutions provided in the example embodiments of the present application that, the present application extracts a feature word and a sentiment word associated with each other from evaluation information of a data object. The feature word may be a word for describing a detail of the data object, such as “collar” or “cuff”; and the sentiment word associated with the feature word may be a word for evaluating the detail, such as “good” or “unique”. The present application may determine a representative feature word for feature words describing a same detail to implement unification of the feature words. For example, for the feature words such as “collar” and “neckline”, a representative feature word corresponding thereto may be “collar”. Then, the present application may judge, according to a sentiment word describing the same detail, whether a user who has purchased the data object likes or dislikes the detail, thereby obtaining a representative sentiment word corresponding to the representative feature word. Therefore, description information for describing the detail of the data object may be generated according to the representative feature word and the corresponding representative sentiment word. Therefore, the description information generated with the technical solution of the present application can include a statement for describing the detail of the data object, thereby improving the accuracy of data object description.

Specific example embodiments of the present application are disclosed in detail with reference to the subsequent descriptions and accompanying drawings, and manners with which the principle of the present application can be employed are specified. It should be understood that the scope of the example embodiments of the present application is not limited thereto. The example embodiments of the present application include numerous variations, modifications and equivalences within the spirit and the scope of terms of the appended claims.

A feature described and/or shown for an example embodiment may be used in one or more other example embodiments in an identical or similar manner, be combined with a feature in another example embodiment, or replace a feature in another example embodiment.

It should be emphasized that, the term “include/comprise” refers to existence of a feature, assembly, step, or component when used in this text, but does not exclude existence or addition of one or more other features, assemblies, steps, or components.

### BRIEF DESCRIPTION OF THE DRAWINGS

Accompanying drawings provide further understanding on the example embodiments of the present application, and constitute a part of the specification. The accompanying drawings exemplify the example embodiments of the present application, and illustrate the principle of the present application together with text descriptions. Apparently, the accompanying drawings described below are merely some example embodiments of the present application, and other accompanying drawings can further be obtained according to these accompanying drawings by those of ordinary skill in the art without creative labor. In the accompanying drawings:

FIG. 1 is a flowchart of a data object description information generation method according to an example embodiment of the present application;

FIG. 2 is a schematic diagram of a data object description information generation method according to an example embodiment of the present application;

FIG. 3 is a block diagram of a data object description information presentation system according to the present application;

FIG. 4 is a flowchart of a method of establishing a preset lexicon according to an example embodiment of the present application;

FIG. 5 is a flowchart of a method of determining a representative sentiment word according to an example embodiment of the present application;

FIG. 6 is a flowchart of a method of generating a description phrase according to an example embodiment of the present application;

FIG. 7 is a functional module diagram of an electronic device according to an example embodiment of the present application;

FIG. 8 is a functional module diagram of an electronic device according to another example embodiment of the present application;

FIG. 9 is a flowchart of a data object description information generation method according to another example embodiment of the present application;

FIG. 10 is a flowchart of a data object description information generation method according to another example embodiment of the present application;

FIG. 11 is a flowchart of a data object description information presentation method according to another example embodiment of the present application; and

FIG. 12 is a schematic diagram of the page data according to the present application;

FIG. 13 is a functional module diagram of an electronic device according to the present application.

### DETAILED DESCRIPTION

For those skilled in the art to better understand the technical solutions in the present application, the technical solutions in the example embodiments of the present application are further described in detail below through the accompanying drawings. Apparently, the described example embodiments are merely some example embodiments of the present application and do not constitute limitation to the present application. Any other embodiments based on the example embodiment of the present application, derived by those of ordinary skill in the art, without any creative efforts, shall all fall within the protection scope of the present application.

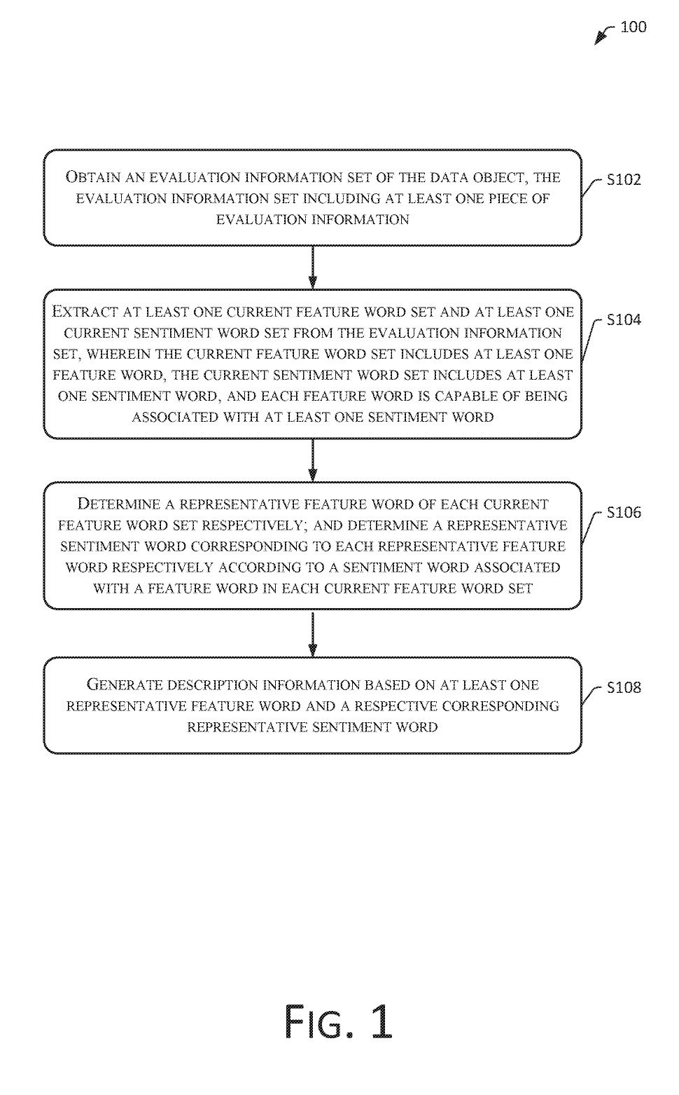

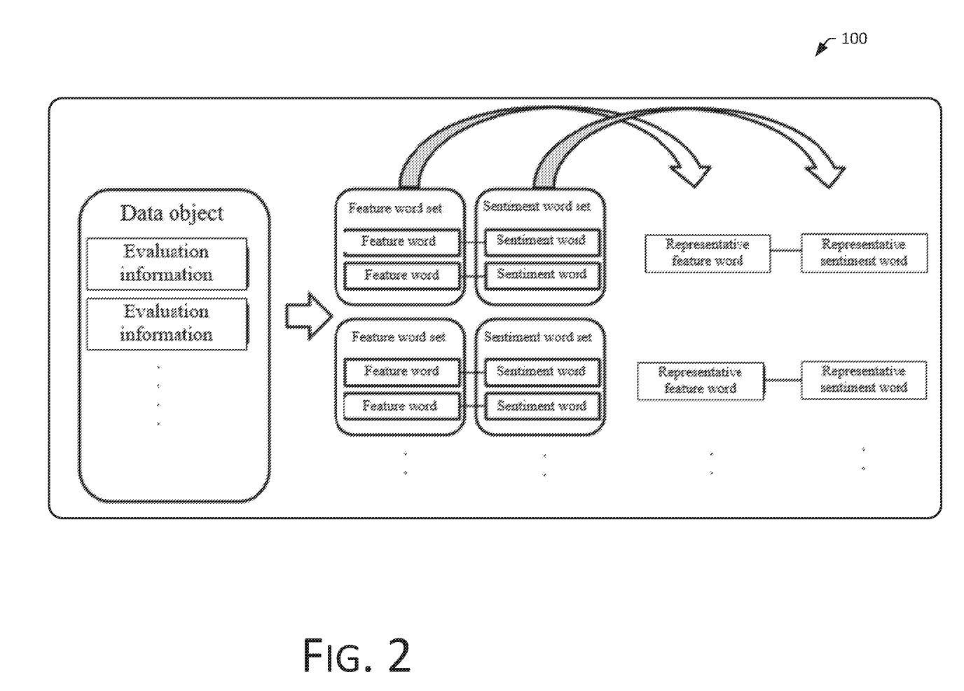

Referring to FIG. 1 and FIG. 2, a data object description information generation method 100 according to an example embodiment of the present application may include the following steps.

Step S102: an evaluation information set of the data object is obtained, the evaluation information set including at least one piece of evaluation information.

In this example embodiment, the data object may be a product or service sold in a network platform. The data object may be a physical article, such as articles of daily use, computer consumables, foods, and electronic devices. The data object may also be a virtual commodity, such as game currency and household services.

In this example embodiment, the product or service represented by the data object may be sold through a network sales platform. The network sales platform may be, for example, Taobao™, Jingdong™, Amazon™, etc. Each network sales platform may correspond to an application respectively, and by using the application, a user may complete purchasing and evaluating the product or service represented by the data object. The application may be, for example, a Taobao™ client terminal, a Tmall™ client terminal, a Jingdong™ client terminal, and the like running on a terminal device. The application may provide a comment area for each product or service. Comment information entered by a user who purchases the product or service may be presented in the comment area.

In this example embodiment, the comment information of the product or service may be stored in a background business server corresponding to the application. The comment information of the product or service may form a comment information set, and the comment information set includes at least one piece of evaluation information of the product or service.

In this example embodiment, obtaining a comment information set of the data object may be performed by the background business server corresponding to the application. Comment information sets of multiple data objects may be stored in the background business server. Associated data object and comment information set may both carry a same identification. The identification may be, for example, a numerical symbol of the data object in the network sales platform. Through a designated identification, the background business server can thereby obtain a comment information set of a product or service corresponding to the designated identification.

In this example embodiment, obtaining a comment information set of the data object may further be performed by a device having data storage and calculation functions. The device may be, for example, a mobile smart phone, a computer (including a notebook computer, a desktop computer, and a server), a tablet electronic device, a personal digital assistant (PDA), or an intelligent wearable device. The device may access a background business server corresponding to the application. In this way, through a designated identification, the device can thereby obtain a comment information set of a product or service corresponding to the designated identification from the background business server.

In this example embodiment, the step S102 of obtaining the evaluation information set of the data object may include: reading an evaluation information set of the data object from a storage medium storing the evaluation information set or receiving an evaluation information set of the data object sent by another device. Specifically, comment information sets of multiple data objects may be stored in the storage medium. Associated data object and comment information set may both carry a same identification. The identification may be, for example, a numerical symbol of the data object in the network sales platform. Through a designated identification, an evaluation information set of a product or service corresponding to the designated identification may be read from the storage medium. Moreover, the evaluation information set of the data object may be stored in another device. In this example embodiment, a data acquisition request may be sent to another device storing the evaluation information set of the data object. In this way, after receiving the data acquisition request, another device may send the evaluation information set of the data object, thereby obtaining the evaluation information set of the data object by data reception.

Step S104: at least one current feature word set and at least one current sentiment word set are extracted from the evaluation information set, wherein the current feature word set includes at least one feature word, the current sentiment word set includes at least one sentiment word, and each feature word is capable of being associated with at least one sentiment word.

In this example embodiment, the feature word may be a word for describing a detail of the data object. For example, if the data object is a one-piece dress, the feature word may be “collar”, “cuff”, “waistline”, or the like. A sentiment word associated with the feature word may be a word for evaluating the detail, for example, “good”, “unique”, “bad”, or the like. For instance, in evaluation information “unique collar design”, “collar” may be the feature word, and “unique” may be the sentiment word associated with the feature word “collar”.

In this example embodiment, the association between the feature word and the sentiment word may be embodied in that: the feature word and the sentiment word associated with each other are located in a same piece of evaluation information. For example, in the evaluation information “unique collar design”, “collar” and “unique” are located in the same piece of evaluation information. Therefore, the feature word “collar” and the sentiment word “unique” extracted from the evaluation information are associated with each other. In another piece of evaluation information “the collar is ugly”, a feature word “collar” and a sentiment word “ugly” extracted therefrom are also associated with each other. It can be seen that, different sentiment words may be associated with a same feature word in the evaluation information set. The association may further be embodied in that the sentiment word has a semantic modification relationship with the feature word. The modification relationship may be obtained through analysis based on a semantic analysis algorithm. Specifically, the semantic analysis algorithm may be, for example, a single-step algorithm or a crawler algorithm. Each piece of evaluation information may be converted into a statement vector by using the semantic analysis algorithm. Two words having a semantic modification relationship may be screened out by analyzing word vectors in the statement vector. Then, the two words screened out may be classified into a feature word and a sentiment word according to different parts of speech.

It should be noted that, only one sentiment word may be included in some evaluation information, and a feature word associated with the sentiment word is omitted. For example, the evaluation information may be “cheap” or “well-fitting”. Such evaluation information generally includes merely the sentiment word for describing a product or service, but does not specify a feature word associated with the sentiment word. In this example embodiment, the feature word associated with the sentiment word may be deduced according to a natural language structure. For example, for the evaluation information “cheap”, a feature word extracted from the evaluation information may be price as “cheap” is generally associated with “price”. In this way, “price” and “cheap” may be used as a feature word and a sentiment word associated with each other. Likewise, for the evaluation information “well-fitting”, it can be deduced that “size” is described by “well-fitting”, and therefore, “size” and “well-fitting” may be used as a feature word and a sentiment word associated with each other in this piece of evaluation information. In this example embodiment, the method of extracting the current feature word set and the current sentiment word set from the evaluation information set may include: conducting semantic analysis on evaluation information in the evaluation information set by using the semantic analysis algorithm, thereby obtaining a feature word and a sentiment word having a semantic modification relationship in the evaluation information. Specifically, the semantic analysis algorithm may be, for example, a single-step algorithm or a crawler algorithm. Each piece of evaluation information may be converted into a statement vector by using the semantic analysis algorithm. Two words having a semantic modification relationship may be screened out by analyzing word vectors in the statement vector. Then, the two words screened out may be classified into a feature word and a sentiment word according to different parts of speech. In this way, different evaluation information may be analyzed to obtain different feature words and sentiment words. The feature words and the sentiment words may therefore form a current feature word set and a current sentiment word set respectively.

In this example embodiment, the step S104 of extracting the current feature word set and the current sentiment word set from the evaluation information set may further include: obtaining matched feature words and sentiment words from evaluation information of the evaluation information set according to words in a preset lexicon by using a word matching method. Specifically, the lexicon may be formed by words included in evaluation information sets of different data objects. When the lexicon is formed, evaluation information in the evaluation information set may be segmented to obtain several words. A word set constructed by the several words may be the lexicon.

In this example embodiment, in at least one current feature word set, each current feature word set may be corresponding to one attribute of the data object. Implementation of at least one current feature word set may be corresponding to at least one attribute, and the generated description information may describe the data object from the perspective of at least one attribute. In this example embodiment, the attribute of the data object may represent a detail feature of the data object. For example, for a product “one-piece dress”, attributes thereof may include, for example, collar, cuff, skirt hemline, color, applicable populations, texture, and the like. Each attribute may be corresponding to a current feature word set. For example, words in a current feature word set corresponding to style may include feature words such as “collar”, “collarband”, and “neckline”. Generally, the data object has at least one attribute, and therefore, there is at least one current feature word set corresponding to the attribute of the data object.

Step S106: a representative feature word of each current feature word set is determined respectively; and a representative sentiment word corresponding to each representative feature word is determined respectively according to a sentiment word associated with a feature word in each current feature word set.

In this example embodiment, feature words belonging to a same current feature word set may have identical or similar meanings. Therefore, a representative feature word may be determined respectively for the at least one current feature word set. For example, the current feature word set includes feature words such as “collarband”, “collar”, and “neckline”, and a representative feature word corresponding to the current feature word set may be “collar”. Different representative feature words may be obtained for different current feature word sets. For example, representative feature words of the data object may be “collar”, “shoulder”, “skirt hemline”, and “waistline”. In this way, although feature words extracted from the comment information set may not be completely the same, a same representative feature word may be used for representation as long as the feature words have identical or similar meanings. For example, feature words extracted from three pieces of evaluation information “the collar is unique”, “the collarband is poor in workmanship”, and “the neckline is beautiful” are “collar”, “collarband”, and “neckline” respectively. Although the three feature words are not completely identical, the three feature words belong to a same current feature word set, and a representative feature word corresponding to the current feature word set is “collar”. Therefore, the feature words involved in the three pieces of evaluation information may be represented uniformly by using “collar”.

In this example embodiment, different users may have different comments on a same feature of a product or service as the users who purchase the product or service have different opinions. For example, for the collar of a one-piece dress, the meaning expressed by some comment information may be that the collar is beautiful, and the meaning expressed by some comment information may be that the collar is ugly. In this case, statistics need to be conducted on sentiment words extracted from the comment information to generate description information about the collar of the product, to determine how users purchasing the product evaluate the collar.

In this example embodiment, a representative sentiment word corresponding to each representative feature word may be determined respectively according to a sentiment word associated with a feature word belonging to the same current feature word set. Specifically, the current feature word set may be, for example, a current feature word set having the meaning of “collar”, and feature words belonging to the current feature word set that are extracted from the comment information may include “collar”, “collarband”, and “neckline”, and the representative feature word of the current feature word set is “collar”. Sentiment words associated with the feature words may be, for example, “excellent”, “great”, and “not so good”, wherein “collar” is associated with “excellent”, “collarband” is associated with “great”, and “neckline” is associated with “not so good”. In an actual application scenario, a group of a feature word and a sentiment word associated with each other may be extracted from each piece of comment information, and therefore, feature words having identical or similar meanings may have many associated sentiment words, and only three sentiment words are exemplified in the foregoing. In this example embodiment, statistics may be conducted on the three sentiment words exemplified in the foregoing, wherein, two of them express a positive sentiment, namely, “excellent” and “great”, and one of them expresses a negative sentiment, that is, “not so good”. As the quantity of sentiment words expressing the positive sentiment is more than the quantity of sentiment words expressing the negative sentiment, it may be determined that users' comments on the representative feature word “collar” are positive. Therefore, the above positive sentiment word “excellent” may be determined as the representative sentiment word corresponding to the representative feature word “collar”.

In this example embodiment, for different representative feature words, representative sentiment words corresponding thereto may be determined in the above method. By use of the processing method of this example embodiment, a large amount of comment information in the comment information set may be refined into a compact representative feature word and a corresponding representative sentiment word. For example, there are three pieces of comment information “the collar is unique”, “the collarband is poor in workmanship”, and “the neckline is beautiful” about a collar of a product in comment information, a representative feature word refined therefrom may be “collar”, and a corresponding representative sentiment word may be “unique”. For another representative feature word, a corresponding representative sentiment word may also be determined according to the same method.

Step S108: description information is generated based on at least one representative feature word and a respective corresponding representative sentiment word.

In this example embodiment, after each representative feature word and a corresponding representative sentiment word are determined, description information of the data object may be generated according to each representative feature word and the corresponding representative sentiment word. Specifically, it is assumed that the representative feature words are “collar”, “cuff”, and “cloth material”, and representative sentiment words corresponding to the representative feature words are “unique”, “fine workmanship”, and “soft” respectively; therefore, description information of the product may be generated as: “unique collar, cuff with fine workmanship, and soft cloth material”. The generated description information may include at least one description phrase. For example, the above description information may include three description phrases “unique collar”, “cuff with fine workmanship”, and “soft cloth material”. Each description phrase may include the representative feature word and the representative sentiment word corresponding to the representative feature word. For example, the description phrase “cuff with fine workmanship” may include the representative feature word “cuff” and the corresponding representative sentiment word “fine workmanship”. In this way, multiple representative feature words related to the data object and respective corresponding representative sentiment words may be finally obtained according to the evaluation information set of the data object, thereby generating description information that more accurately describes the data object.

In this example embodiment, the step 108 of generating the description information may include: combining a representative feature word and a corresponding representative sentiment word having a semantic modification relationship into a character string meeting the language expression habit. For example, the representative feature word and the corresponding representative sentiment word having a semantic modification relationship may be “cloth material” and “soft” respectively, and then the two words may be combined into a character string meeting the language expression habit, that is, “soft cloth material”. Further, a modifier may be added to the generated character string according to the language expression habit. For example, a modifier “relatively” may be added to “soft cloth material” to form “relatively soft cloth material”, thus being more in line with the user's language expression habit.

It should be noted that, the above steps S102 to S108 may be used as a method of generating description information of a data object. The above steps S102 to S108 may be performed in a background business server corresponding to the application, and may also be performed in a device having data storage and calculation functions, which is not limited in the present application.

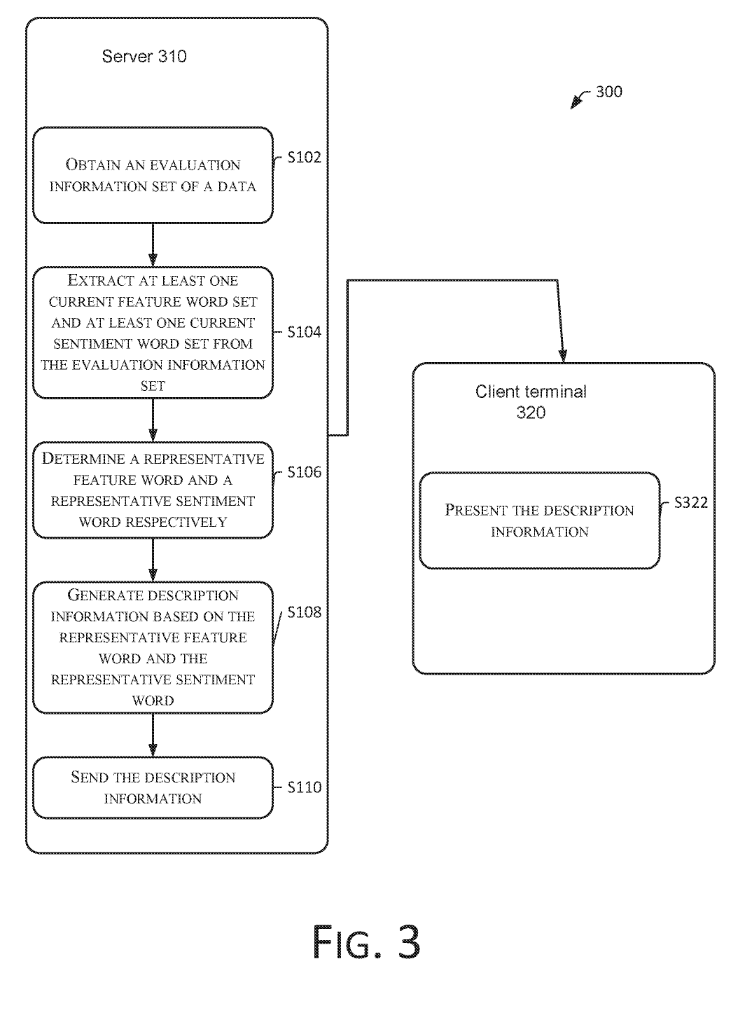

Referring to FIG. 3, a data object description information presentation system 300 is further provided in an example embodiment of the present application. The description information presentation system 300 may include a server 310 and a client terminal 320. The server 310 may perform the above steps S102 to S108. Steps performed by the server may further include S110: sending the description information to the client terminal 320. Therefore, interaction between the server and the client terminal may be implemented. The server 310 provides the generated description information for the client terminal 320, such that the client terminal 320 may perform further processing. For example, the client terminal 320 may present the description information to the user.

In this example embodiment, the step S110 of the sending the description information to the client terminal by the server may include: sending the description information through a wired data communication network or a wireless data communication network. The sending may be based on a network transmission protocol that can achieve the above objective, specifically, for example, an Http protocol, a TCP/IP protocol, or the like.

In this example embodiment, a step S322 performed by the client terminal may include: presenting the description information.

In this example embodiment, after the description information of the data object is generated, the client terminal may present the description information at a preset position (for example, above the comment area) of the comment area of the data object. Specifically, when the user clicks and views comment information of the data object in the application, the application may send a request for loading comment information to the background business server. After receiving the request, the background business server may return comment information related to the data object and generated description information to the application, and display the comment information and the description information in the comment area preset in the application. Definitely, if the description information is generated by a device having data storage and calculation functions, after receiving the request for loading comment information sent by the application, the background business server may obtain the generated description information from the device, or obtain the comment information and the description information of the data object from the device, and return the comment information and the description information of the data object to the application. The comment information and the description information of the data object are presented in the comment area preset in the application.

In this example embodiment, the client terminal 320 may include, for example, a mobile smart phone, a computer (including a notebook computer, a desktop computer, and a server), a tablet electronic device, a personal digital assistant (PDA), or an intelligent wearable device. The client terminal may also be a software program running on the above hardware device.

In an example application scenario of the present application, when corresponding description information needs to be generated for a product, a one-piece dress, in Taobao™ mobile, all comment information of the product, the one-piece dress, may be obtained in advance by a background business server of the Taobao™ mobile to form a comment information set corresponding to the product, the one-piece dress. The background business server may extract 150 word groups from the comment information set, and each word group may include a feature word and a sentiment word associated with each other. For example, in the 150 word groups, there are 120 word groups involve feature words related to “logistics”. Feature words used by users may be, for example, “logistics”, “delivery”, “express delivery”, and the like. The feature words used by the users all belong to a current feature word set whose representative feature word is “logistics”. Moreover, the 150 word groups further involve feature words related to representative feature words such as “service attitude”, “collar”, “cuff”, “size”, and “cloth material”. By using “logistics” as an example for analysis, in the 120 pieces of evaluation information involving “logistics”, 100 pieces of them consider that the logistics is fast and satisfactory; while other 20 pieces of them consider that the logistics is unsatisfactory. In this way, there are more evaluations considering that the logistics is good in the evaluation information of the product, and therefore, a representative sentiment word corresponding to the representative feature word “logistics” may be determined as “fast”, thereby generating a description phrase “fast logistics” of the one-piece dress. Likewise, different description phrases may be generated for other representative feature words and corresponding representative sentiment words, for example, “good service attitude”, “ugly collar”, “unique cuff design”, “slightly large in size”, and “soft cloth material”. In this way, all the generated description phrases are integrated to generate description information of the product, the one-piece dress: “about the product: fast logistics, good service attitude, ugly collar, unique cuff design, slightly large in size, and soft cloth material. Please consult before purchasing.” The start “about the product:” of the description information and the end “Please consult before purchasing” may be preset character strings, and the description information generated through the technical solution of the present application is located between the start and the end. In this way, when a user needs to view evaluation information of the one-piece dress, the background business server may return all evaluation information of the one-piece dress and the generated description information to the application, and present them in the comment area of the application for the user to view.

It can be seen from the technical solutions provided in the example embodiments of the present application that, the present application extracts a feature word and a sentiment word associated with each other from evaluation information of a data object. The feature word may be a word for describing a detail of the data object, such as “collar” or “cuff”; and the sentiment word associated with the feature word may be a word for evaluating the detail, such as “good” or “unique”. The present application may determine a representative feature word for feature words describing a same detail to implement unification of the feature words. For example, for the feature words such as “collar” and “neckline”, a corresponding representative feature word may be “collar”. Then, the present application may judge, according to a sentiment word describing the same detail, whether a user who has purchased the data object likes or dislikes the detail, thereby obtaining a representative sentiment word corresponding to the representative feature word. Therefore, description information for describing the detail of the data object may be generated according to the representative feature word and the corresponding representative sentiment word. Therefore, the description information generated with the technical solution of the present application can include a statement for describing the detail of the data object, thereby improving the accuracy of data object description.

In an example embodiment of the present application, the step of extracting at least one current feature word set may include: extracting at least one current feature word set from the evaluation information set according to a preset lexicon. The preset lexicon has at least one feature word set preset therein, and each feature word set includes at least one feature word. Moreover, the preset lexicon may further have at least one sentiment word set pre-recorded therein, and each sentiment word set includes at least one sentiment word. In this way, the step of extracting at least one current feature word set and at least one current sentiment word set may further include: extracting at least one current sentiment word set from the evaluation information set according to the preset lexicon.

In this example embodiment, a feature word and a sentiment word associated with each other that are extracted from a same piece of evaluation information may form a word group. In this way, the evaluation information set may include a preset quantity of evaluation information. Therefore, a preset quantity of word groups may also be extracted from the evaluation information set.

In this example embodiment, words in the evaluation information may be matched by using words in the preset lexicon to extract feature words and sentiment words in the evaluation information. Specifically, the preset lexicon may include multiple feature words and sentiment words. The feature words and the sentiment words may be classified by a preset rule to form a feature word set and a sentiment word set. Feature words located in the same feature word set may have identical or similar meanings. For example, the feature words such as “collar”, “collarband”, and “neckline” may belong to the same feature word set. Sentiment words located in the same sentiment word set may also have identical or similar meanings. For example, sentiment words expressing a positive sentiment such as “nice”, “unique”, and “good” may belong to a same sentiment word set. All sentiment words in the preset lexicon may also be located in a same sentiment word set to distinguish the sentiment words from the feature words.

In this example embodiment, the feature word in the word group is extracted from the comment information set according to the word in the preset lexicon. Therefore, the feature word in the word group may exist in the preset lexicon. In this way, the feature words in the preset quantity of word groups may belong to at least one current feature word set of the at least one feature word set. For example, the feature words in the preset quantity of word groups may be “collarband”, “collar”, “neckline”, “cuff”, “sleeve”, “skirt hemline”, and “hemline”. Therefore, the three feature words “collarband”, “collar”, and “neckline” may belong to the current feature word set representing the meaning of “collar”; “cuff” and “sleeve” may belong to the current feature word set representing the meaning of “cuff”; and “skirt hemline” and “hemline” may belong to the current feature word set representing the meaning of “skirt hemline”.

In the present application, each feature word set in the preset lexicon may be respectively corresponding to at least one attribute of the data object. For example, the feature word set constructed by “collarband”, “collar”, and “neckline” may be corresponding to the collar attribute of the data object. The feature word set constructed by “cuff” and “sleeve” may be corresponding to the cuff attribute of the data object.

In an example embodiment of the present application, in the step of extracting at least one current feature word and at least one current sentiment word set, a sentiment word associated with a feature word in each current feature word set may be extracted from the evaluation information set through semantic analysis to form at least one sentiment word set.

In this example embodiment, a feature word and a sentiment word located in a same piece of evaluation information may have a modification relationship. For example, for the evaluation information “neckline is too small”, the sentiment word “too small” may be used to modify the feature word “neckline”. In this example embodiment, a sentiment word associated with a feature word in each current feature word set may be extracted from the evaluation information through semantic analysis to form at least one sentiment word set. Sentiment words located in the same sentiment word set may have identical or similar meanings. Specifically, the semantic analysis algorithm may be, for example, a single-step algorithm or a crawler algorithm. Each piece of evaluation information may be converted into a statement vector by using the semantic analysis algorithm. Two words having a modification relationship may be screened out by analyzing word vectors in the statement vector. Then, the two words screened out may be classified into a feature word and a sentiment word according to different parts of speech. In this way, each feature word in the current feature word set may be corresponding to a sentiment word having a modification relationship, and therefore, the sentiment words can form at least one sentiment word set.

It can be seen that the feature word and the sentiment word having a modification relationship may be extracted from the evaluation information set by semantic analysis. In this way, the extracted feature words and sentiment words may form at least one current feature word set and at least one current sentiment word set respectively.

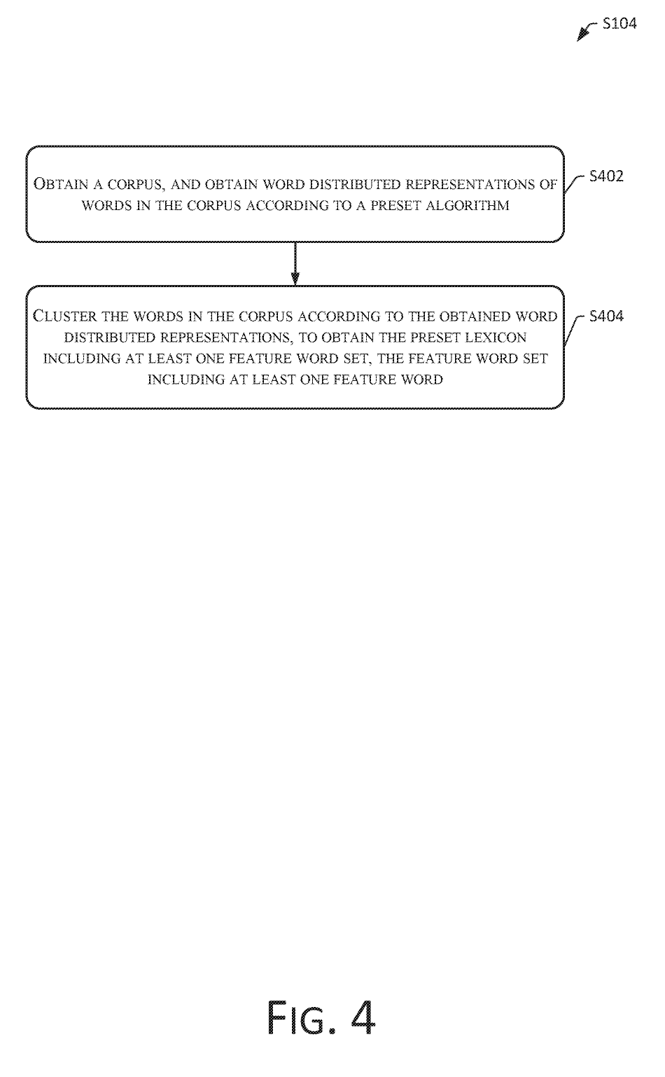

Referring to FIG. 4, in an example embodiment of the present application, the preset lexicon in step S104 may be established by the following steps.

Step S402: a corpus is obtained, and word vectors of words in the corpus are obtained according to a preset algorithm.

In this example embodiment, the corpus may include words appearing in comment information of all data objects in a same category with the data object. For example, for a one-piece dress of a brand in the Taobao™ platform, the corpus may include words appearing in comment information of all products in the category of one-piece dress in the Taobao™ platform. The words in the corpus may include the feature word, and may also include the sentiment word. In this example embodiment, word vectors of words in the corpus may be calculated according to a preset algorithm, thereby quantificationally determining the meaning of each word in a digitalized method. In this example embodiment, the preset algorithm may be, for example, a CBOW algorithm, a Skip-Gram algorithm, or a GloVe algorithm.

In this example embodiment, the method of obtaining the corpus may include: reading the corpus from a storage medium storing the corpus or receiving the corpus sent by another device. Specifically, the storage medium may store evaluation information sets of multiple data objects, and the evaluation information sets may be combined into the corpus. Associated data object and comment information set may both carry a same identification. The identification may be, for example, a numerical symbol of the data object in the network sales platform. Through a designated identification, an evaluation information set of a product or service corresponding to the designated identification may be read from the storage medium, and the read evaluation information set may be used as the corpus. Moreover, the corpus may be stored in another device. In this example embodiment, a data acquisition request may be sent to another device storing the corpus. In this way, after receiving the data acquisition request, another device may send the corpus, thereby obtaining the corpus by data reception.

Step S404: the words in the corpus are clustered according to the obtained word vectors to obtain the preset lexicon including at least one feature word set, the feature word set including at least one feature word.

In this example embodiment, word vectors corresponding to words having identical or similar meanings are generally close to each other. In this way, by clustering the words in the corpus, the words having identical or similar meanings may be classified into a same word set. Specifically, in this example embodiment, the words in the corpus may be clustered by using a clustering algorithm such as a K-means algorithm, an agglomerative hierarchical clustering algorithm, or a DBSCAN algorithm. By using the K-means algorithm as an example, K center words may first be determined in the corpus, then distances between each word in the corpus and the K center words may be calculated according to the word vectors, and the words in the corpus may be associated with the center word at a closer distance, thereby forming K word sets. Then, center words in the K word sets may be recalculated for accuracy of the clustering, and the words in the corpus are clustered again with the method of calculating distances, such that K re-clustered word sets may be obtained. In this way, calculating of center words and re-clustering are performed repeatedly until a preset number of clustering times is reached or the clustered word set does not change any more. In this way, after the words in the corpus are clustered, the preset lexicon including at least one feature word set may be obtained, the feature word set including at least one feature word.

In an example embodiment of the present application, when the feature word set in the preset lexicon is obtained by clustering word vectors, a representative feature word of the at least one current feature word set may be obtained by calculating a center word vector. Specifically, in this example embodiment, word vectors of the words in the current feature word set may be averaged to obtain a center word vector. For example, the current feature word set includes 5 words, and word vectors of the 5 words are respectively (a₁, b₁) (a₂, b₂), (a₃, b₃), (a₄, b₄) and (a₅, b₅). Then, corresponding elements in the 5 word vectors may be added and then divided by the number of the word vectors to obtain a center word vector.

After the center word vector is obtained through calculation, if the center word vector is just corresponding to a feature word in the current feature word set, the feature word corresponding to the center word vector may be determined as the representative feature word. However, the center word vector calculated through the above formula sometimes may not have a corresponding feature word in the current feature word set, and in this case, a feature word corresponding to a word vector closest to the center word vector may be determined as the representative feature word.

In another example embodiment of the present application, to simplify the method of obtaining the representative feature word, statistics may be conducted on the number of times each feature word in each current feature word set is matched in the evaluation information set, and a feature word having the maximum number of repetition times is determined as the representative feature word. For example, in a current feature word set, the number of repetition times of the feature word “collar” is 5, the numbers of repetition times of “neckline” and “collarband” are both 2, and therefore, “collar” may be determined as the representative feature word.

Correspondingly, in an example embodiment of the present application, statistics may be conducted on the number of times a sentiment word associated with a feature word in each current feature word set is repeated, and therefore, a sentiment word having the maximum number of repetition times may be used as the representative sentiment word corresponding to each representative feature word. For example, in the current feature word set of which the representative feature word is “collar”, each feature word may be associated with a sentiment word. In the multiple sentiment words, the number of repetition times of “unique” is the largest. Therefore, in this example embodiment, “unique” may be determined as the representative sentiment word of “collar”.

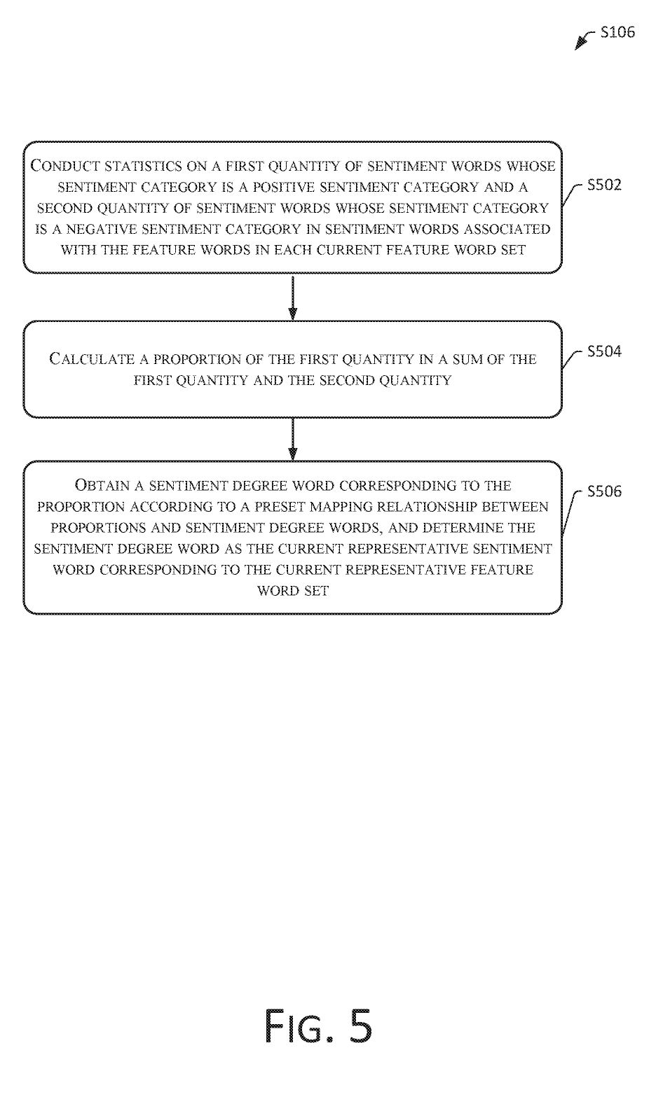

In an example embodiment of the present application, categories of the sentiment words may include a positive sentiment category and a negative sentiment category. Therefore, a sentiment category of the sentiment word associated with the feature word may be analyzed to determine a representative sentiment word corresponding to the representative feature word. Referring to FIG. 5, a representative sentiment word corresponding to each representative feature word may be determined according to the following steps.

Step S502: statistics are conducted on a first quantity of sentiment words whose sentiment category is the positive sentiment category and a second quantity of sentiment words whose sentiment category is the negative sentiment category in sentiment words associated with the feature words in each current feature word set.

Step S504: a proportion of the first quantity in a sum of the first quantity and the second quantity is calculated.

Step S506: a sentiment degree word corresponding to the proportion is obtained according to a preset mapping relationship between proportions and sentiment degree words, and the sentiment degree word is determined as the representative sentiment word corresponding to the representative feature word set.

In this example embodiment, it is assumed that the current feature word set related to “collar” includes three feature words “collar”, “neckline”, and “collarband” extracted from the comment information set, wherein the sentiment word corresponding to “collar” may be “excellent”, the sentiment word corresponding to “neckline” may be “not so good”, and the sentiment word corresponding to “collarband” may be “delicate”, and therefore, it can be known from statistics that there are 2 sentiment words in the positive sentiment category, and 1 sentiment word in the negative sentiment category. It should be noted that, in an actual application, there may be more than one sentiment words associated with the feature word “collar”. For example, some evaluation information may be “the collar is good”, and some evaluation information may be “the collar is not so good”. In this example embodiment, one associated sentiment word is exemplified for each feature word to facilitate description; however, those skilled in the art should know that this does not mean that each feature word can merely be associated with one sentiment word.

In this example embodiment, after statistics is conducted on the first quantity and the second quantity of sentiment categories to which the sentiment words belong, a proportion of the first quantity in a sum of the first quantity and the second quantity may be calculated. For example, in the above example, the first quantity may be 2, the second quantity may be 1, and therefore, a proportion of the first quantity in a sum of the first quantity and the second quantity may be ⅔. In this example embodiment, a mapping relationship between proportions and sentiment degree words may be preset. For example, a sentiment degree word corresponding to a proportion of 0 may be “bad”, a sentiment degree word corresponding to a proportion of 0.5 may be “common”, and a sentiment degree word corresponding to a proportion of 0.9 may be “good”. It should be noted that, in the mapping relationship between proportions and sentiment degree words, the proportion may be an interval. For example, proportions within an interval greater than or equal to 0 and less than or equal to 0.2 may be corresponding to a same sentiment degree word. In this way, a sentiment degree word corresponding to the proportion may be obtained according to the preset mapping relationship between proportions and sentiment degree words. Therefore, the sentiment degree word may be determined as the representative sentiment word corresponding to the representative feature word.

In an example embodiment of the present application, after the proportion is obtained through calculation, the calculated proportion may be further added into the description information as a parameter. In this example embodiment, the calculated proportion may be considered as a praise rate of a feature in the data object. For example, a proportion of sentiment words in a positive sentiment category corresponding to the feature word “service attitude” is 90%, and it indicates that the service attitude of a seller of the data object is approved by most users. Therefore, a phrase of “praise rate being 90%” is added after the description phrase “good service attitude”, thereby forming a description phrase “good service attitude (praise rate being 90%)” to indicate the specific praise status of a feature of the data object more precisely.

In an example embodiment of the present application, the preset lexicon may further include at least one sentiment word set in addition to including the feature word set. Correspondingly, the sentiment words in the preset quantity of word groups may belong to at least one current sentiment word set of the at least one sentiment word set. Likewise, the sentiment word in the sentiment word set may also be obtained by clustering a word vector. Sentiment words belonging to the same current sentiment word set may have identical or similar meanings. Sentiment words such as “excellent”, “great”, and “very satisfied” may belong to a same current sentiment word set. In this way, each current sentiment word set may be corresponding to one representative sentiment word. Specifically, in this example embodiment, word vectors of the words in the current sentiment word set may be averaged to obtain a center word vector, and a sentiment word corresponding to the center word vector or a sentiment word corresponding to a word vector closest to the center word vector may be determined as the representative sentiment word corresponding to the current sentiment word set. The specific calculation process is similar to the process of calculating the representative feature word, and is not repeated herein. It should be noted that, in this example embodiment, the current sentiment word set may be classified according to sentiment categories. In other words, the current sentiment word set may include a current positive sentiment word set and a current negative sentiment word set.

In an example embodiment of the present application, after a representative sentiment word corresponding to each current sentiment word set is determined, a sentiment category of the sentiment word associated with the feature word belonging to the same current feature word set may be analyzed to determine a representative sentiment word corresponding to the representative feature word. Specifically, in this example embodiment, statistics may be conducted on a third quantity of sentiment words whose sentiment category is the positive sentiment category and a fourth quantity of sentiment words whose sentiment category is the negative sentiment category in sentiment words associated with the feature words belonging to the same current feature word set. For example, it is assumed that the current feature word set related to “collar” includes three feature words “collar”, “neckline”, and “collarband” extracted from the comment information set, wherein the sentiment word corresponding to “collar” may be “excellent”, the sentiment word corresponding to “neckline” may be “not so good”, and the sentiment word corresponding to “collarband” may be “delicate”, and therefore, it can be known from statistics that there are 2 sentiment words in the positive sentiment category, and 1 sentiment word in the negative sentiment category. In other words, the third quantity is 2, and the fourth quantity is 1. Moreover, the two sentiment words “excellent” and “delicate” may belong to the same current positive sentiment word set, and “not so good” may belong to the current negative sentiment word set.

In this example embodiment, when the third quantity is greater than the fourth quantity, a representative sentiment word corresponding to the current positive sentiment word set is determined as the representative sentiment word corresponding to the representative feature word. For example, the representative sentiment word corresponding to the current positive sentiment word set to which the above “excellent” and “delicate” belong is “good”, and then, as the third quantity is greater than the fourth quantity, a representative sentiment word corresponding to the representative feature word “collar” may be determined as “good”.

In contrast, when the third quantity is less than the fourth quantity, a representative sentiment word corresponding to the current negative sentiment word set is determined as the representative sentiment word corresponding to the representative feature word.

In an example embodiment of the present application, in the step of determining the representative sentiment word, statistics may be conducted on a quantity of sentiment words belonging to a same sentiment word set in sentiment words associated with the feature words in each current feature word set. For example, in the current feature word set representing “collar”, each feature word may be associated with a sentiment word. The sentiment words are classified into positive sentiment words and negative sentiment words, and therefore, the sentiment words associated with the feature words may be located in different sentiment word sets. In this example embodiment, statistics may be conducted on the quantity of sentiment words belong to the same sentiment word set. In this way, when the quantity of sentiment words in a sentiment word set is the maximum, it indicates an overall evaluation tendency of users. For example, when the quantity of sentiment words in the positive sentiment word set is the maximum, it indicates an overall evaluation tendency of users in the evaluation information set is that the data object is good. In contrast, when the quantity of sentiment words in the negative sentiment word set is the maximum, it indicates an overall evaluation tendency of users in the evaluation information set is that the data object is poor. Accordingly, in this example embodiment, the sentiment word set having the maximum quantity may be used as the current sentiment word set corresponding to the representative feature word respectively, and a representative sentiment word corresponding to each representative feature word may be obtained respectively according to the current sentiment word set.

In an example embodiment of the present application, when the representative sentiment word corresponding to each representative feature word is obtained, word vectors of words in the current sentiment word set may also be processed. Specifically, word vectors of words in each current sentiment word set are averaged to obtain a center word vector. After the center word vector is obtained, a sentiment word corresponding to the center word vector or a sentiment word corresponding to a word vector closest to the center word vector may be determined as the representative sentiment word corresponding to the current sentiment word set.

In another example embodiment of the present application, to simplify the process of obtaining the representative sentiment word, a sentiment word having the maximum number of matching times in the current sentiment word set within a preset time period may be used as the representative sentiment word; or a sentiment word randomly selected from the current sentiment word set may be used as the representative sentiment word. Wherein, the preset time period may be a time period counting back from the current time, for example, the last six months or the last year. The objective of such processing is that merchants may constantly improve data objects on offer, and appraise information in corresponding evaluation information is generally changed accordingly as the data objects update. Therefore, information extraction performed on the evaluation information in the preset time period may ensure the accuracy of description information of the current data object.

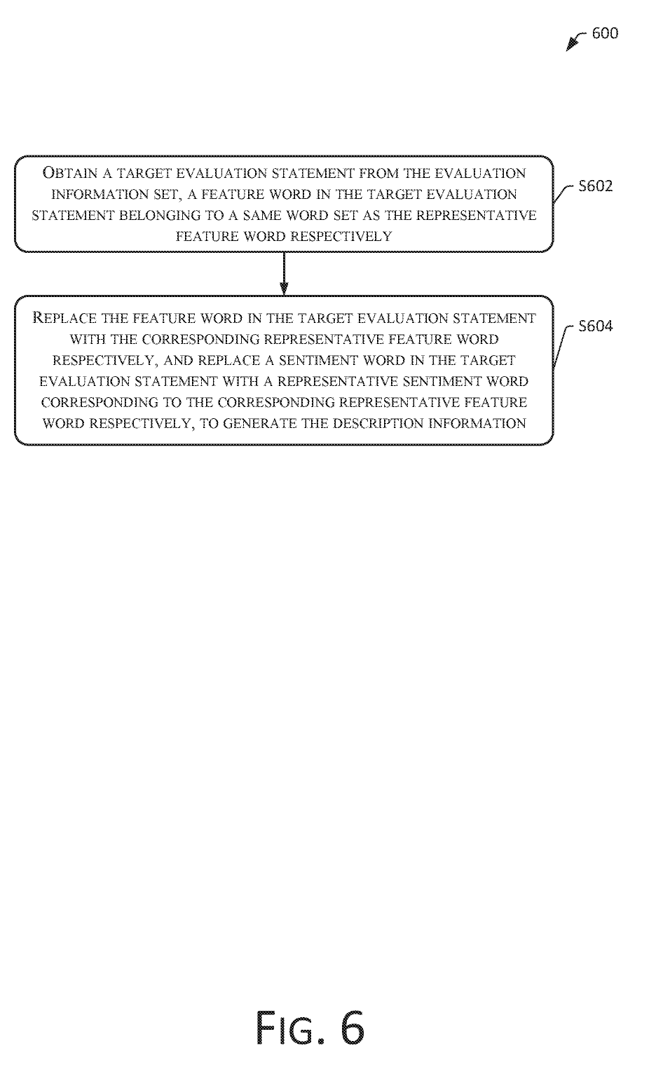

In an example embodiment of the present application, to enable description phrases in the generated description information to be more natural and closer to the real expression manner of users, the description phrases may be generated by using a language organization manner in the evaluation information. Referring to FIG. 6, the description phrases in the description information may be generated through the following steps.

Step S602: a target evaluation statement is obtained from the evaluation information set, a feature word in the target evaluation statement belonging to a same word set as the representative feature word respectively.

Step S604: the feature word in the target evaluation statement is replaced with the corresponding representative feature word respectively, and a sentiment word in the target evaluation statement is replaced with a representative sentiment word corresponding to the corresponding representative feature word respectively, to generate the description information.

In this example embodiment, assume that a description phrase related to “collar” needs to be generated, a target evaluation statement including the meaning of “collar” may be obtained from the evaluation information set. A feature word appearing in the target evaluation statement may be “neckline”, and “neckline” belongs to a same word set as the representative feature word “collar”. Therefore, the language organization method of the target evaluation statement may be applicable to the generated description phrase. For example, the target evaluation statement is “The neckline of this one-piece dress is a great design.” In the target evaluation statement, “neckline” is a feature word, and “great” is a sentiment word. Therefore, to enable the generated description phrase to be in line with the evaluation mood of the user, the feature word in the target evaluation statement may be replaced with the representative feature word, and the sentiment word in the target evaluation statement is replaced with the current representative sentiment word corresponding to the current representative feature word. The representative feature word is “collar”, the corresponding representative sentiment word is “good”, and therefore, the description phrase may be generated as “The collar of this one-piece dress is a good design.”

In an example embodiment of the present application, a standard of selecting the target evaluation statement may be: the target evaluation statement has the maximum repetition rate in the evaluation information set. In this way, the selected target evaluation statement may be in line with most people's language habits, such that the generated description phrase is more natural.

In an example embodiment of the present application, there may be multiple representative feature words corresponding to a same data object. For example, representative feature words corresponding to a one-piece dress may include “collar”, “cuff”, “skirt hemline”, “service attitude”, and “logistics”, and users may concern a unique feature of the one-piece dress, for example, “skirt hemline”, and “logistics” and “service attitude” may be less concerned. In this example embodiment, when the description information includes at least two description phrases, the description phrases may be sorted according to degrees of importance of representative feature words in the description phrases, and the feature more concerned by users is described preferentially. Specifically, in this example embodiment, a priority parameter of each representative feature word in the description information may be determined. The priority parameter may be calculated by using a mutual information algorithm or a TFIDF algorithm.

In this example embodiment, the meaning of calculating the priority parameter of each representative feature word by using the mutual information algorithm or the TFIDF algorithm is described in the following. Assume that in the evaluation information of the one-piece dress, the quantity of evaluation information related to the skirt hemline is 100, and the total quantity of the evaluation information of the one-piece dress is 120. In a set of all products in the whole Taobao™ platform, the quantity of evaluation information related to the skirt hemline of the one-piece dress is 1000, and the total quantity of evaluation information is 20000. Such data indicates that the skirt hemline of the one-piece dress is more concerned in the one-piece dress product, but is less concerned in all the products in the whole Taobao™ platform (this is because other products may not have a skirt hemline). In other words, the feature of skirt hemline is a relatively important feature for the one-piece dress, and the calculated priority parameter thereof is large. As for the feature word “logistics”, the number of times it appears in the evaluation information of the product, the one-piece dress, is quite high. For example, 110 pieces among 120 pieces of evaluation information mention the logistics. However, the number of times the feature logistics appears in all products in the whole Taobao™ platform is also very high. For example, there are 18000 pieces among 20000 pieces of evaluation information, and then, a corresponding priority parameter thereof may be far less than the priority parameter of the skirt hemline.

In this example embodiment, after the priority parameter corresponding to each representative feature word is calculated, the at least two description phrases in the description information may be sorted according to the determined priority parameter. For example, for the two representative feature words: skirt hemline and logistics, the skirt hemline may be described prior to the logistics.

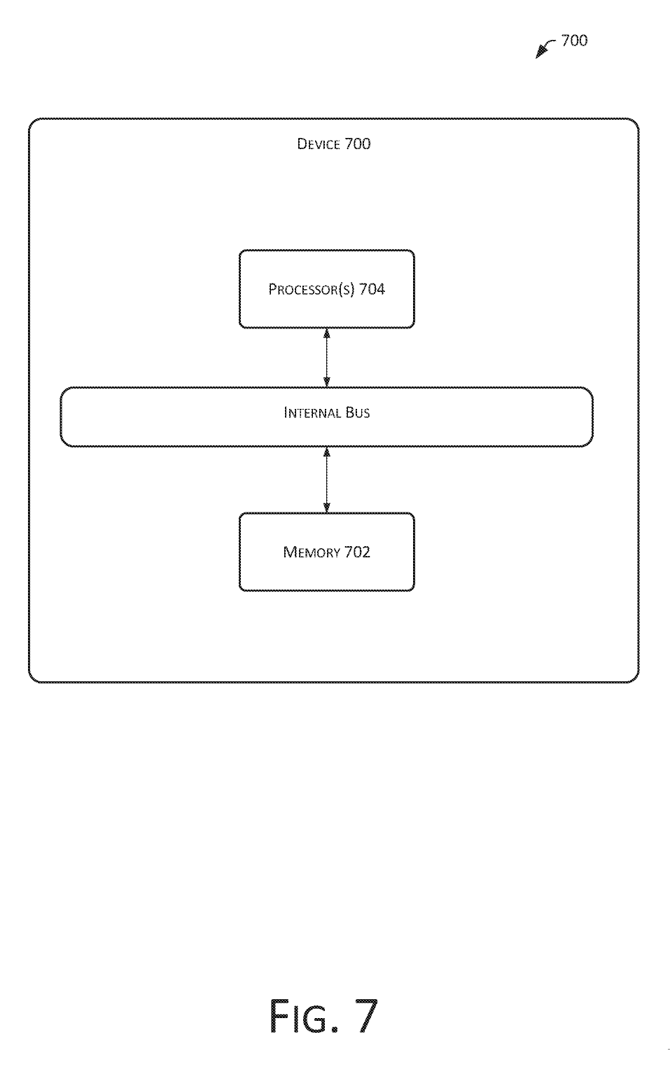

Referring to FIG. 7, the present application further provides an electronic device 700. The electronic device may include a memory 702 and a processor 704.

The memory 702 may store an evaluation information set of a data object, the evaluation information set including at least one piece of evaluation information.

In this example embodiment, the memory 702 may be a memory device configured to store information. In a digital system, a device capable of storing binary data may be a memory. In an integrated circuit, a circuit without a physical form but having a storage function may also be a memory, such as a RAM or a FIFO. In a system, a storage device having a physical form may also be referred to as a memory, such as a memory bank or a TF card.

The processor 704 may extract at least one current feature word set and at least one current sentiment word set from the evaluation information set, wherein the current feature word set includes at least one feature word, the current sentiment word set includes at least one sentiment word, and each feature word is capable of being associated with at least one sentiment word; determine a representative feature word of each current feature word set respectively; determine a representative sentiment word corresponding to each representative feature word respectively according to a sentiment word associated with a feature word in each current feature word set; and generate description information based on at least one representative feature word and a respective corresponding representative sentiment word.

In this example embodiment, the processor 704 may be implemented in any suitable method. For example, the processor may be in the form of, for example, a microprocessor or a processor and a computer readable medium storing computer readable program codes (for example, software or firmware) executable by the (micro)processor, a logic gate, a switch, an Application Specific Integrated Circuit (ASIC), a programmable logic controller, an embedded micro-controller, and so on. This is not limited in the present application.

Specific functions implemented by the memory 702 and the processor 704 in the electronic device 700 disclosed in the above example embodiment may be explained compared with the example embodiment of the data object description information generation method of the present application, which can implement the example embodiment of the data object description information generation method of the present application, and achieve the technical effect of the method example embodiment.

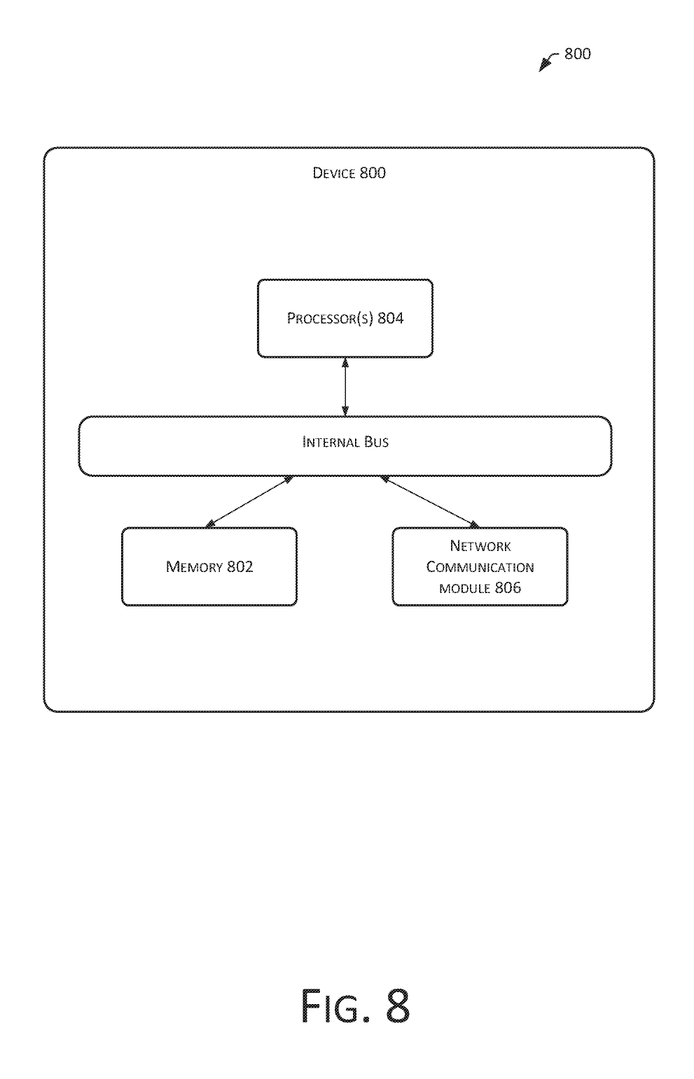

Referring to FIG. 8, another example embodiment of the present application further provides an electronic device 800. The electronic device includes a memory 802, a network communication module 806, and a processor 804.

The memory 802 stores an evaluation information set of a data object, the evaluation information set including at least one piece of evaluation information.

In this example embodiment, the memory may be a memory device configured to store information. In a digital system, a device capable of storing binary data may be a memory. In an integrated circuit, a circuit without a physical form but having a storage function may also be a memory, such as a RAM or a FIFO. In a system, a storage device having a physical form may also be referred to as a memory, such as a memory bank or a TF card.

The network communication module 806 is configured to conduct network data communication.

In this example embodiment, the network communication module can conduct network communication to receive and send data. The network communication module 806 may be set according to a TCP/IP protocol, and may conduct network communication in the protocol frame. Specifically, it may be a wireless mobile network communication chip, such as a GSM or a CDMA. It may also be a Wi-Fi chip or a Bluetooth chip.

The processor 804 can extract at least one current feature word set and at least one current sentiment word set from the evaluation information set, wherein the current feature word set includes at least one feature word, the current sentiment word set includes at least one sentiment word, and each feature word is capable of being associated with at least one sentiment word; determine a representative feature word of each current feature word set respectively; determine a representative sentiment word corresponding to each representative feature word respectively according to a sentiment word associated with a feature word in each current feature word set; generate description information based on at least one representative feature word and a respective corresponding representative sentiment word; and control the network communication module to send the description information.

In this example embodiment, the processor 804 may be implemented in any suitable method. For example, the processor may be in the form of, for example, a microprocessor or a processor and a computer readable medium storing computer readable program codes (for example, software or firmware) executable by the (micro)processor, a logic gate, a switch, an Application Specific Integrated Circuit (ASIC), a programmable logic controller, an embedded micro-controller, and so on. This is not limited in the present application.

Specific functions implemented by the memory 802, the network communication module 806, and the processor 804 in the electronic device 800 disclosed in the above example embodiment may be explained compared with the example embodiment of the data object description information presentation method of the present application, which can implement the example embodiment of the data object description information presentation method of the present application, and achieve the technical effect of the method example embodiment.

The present application further provides a data object description information generation system. The system may include a server and a client terminal.

Steps performed by the server includes: obtaining an evaluation information set of the data object, the evaluation information set including at least one piece of evaluation information; extracting at least one current feature word set and at least one current sentiment word set from the evaluation information set, wherein the current feature word set includes at least one feature word, the current sentiment word set includes at least one sentiment word, and each feature word is capable of being associated with at least one sentiment word; determining a representative feature word of each current feature word set respectively; determining a representative sentiment word corresponding to each representative feature word respectively according to a sentiment word associated with a feature word in each current feature word set; generating description information based on at least one representative feature word and a respective corresponding representative sentiment word; and sending the description information to the client terminal.

A step performed by the client terminal includes: presenting the description information.

In this example embodiment, the server may include a hardware device having a data information processing function, and necessary software required for driving the hardware device to work. The server may be provided with a predetermined port, and description information may be sent to the client terminal through the predetermined port. For example, the server may conduct network data interaction with the client terminal based on a network protocol, such as HTTP, TCP/IP, or FTP, and the network communication module.

In this example embodiment, the client terminal may be a terminal device capable of accessing the communication network based on the network protocol. Specifically, the client terminal may be, for example, a mobile smart phone, a computer (including a notebook computer and a desktop computer), a tablet electronic device, a personal digital assistant (PDA), or an intelligent wearable device. Moreover, the client terminal may also be software running on any of the above-listed devices, such as an Alipay™ client terminal, and a Taobao™ mobile client terminal.

The present application further provides a data object description information generation method. The method may be applied to a client terminal, and may include the following steps.

The client terminal presents a page provided by a server. The page includes a data object, an evaluation information set for the data object, and description information generated based on the evaluation information, and the evaluation information set includes at least one piece of evaluation information.

In this example embodiment, the description information may be generated by the server in the following steps: extracting at least one current feature word set and at least one current sentiment word set from the evaluation information set, wherein the current feature word set includes at least one feature word, the current sentiment word set includes at least one sentiment word, and each feature word is capable of being associated with at least one sentiment word; determining a representative feature word of each feature word respectively; determining a representative sentiment word corresponding to each current feature word set respectively according to a sentiment word associated with a feature word in each feature word set; and generating description information based on at least one representative feature word and a respective corresponding representative sentiment word.

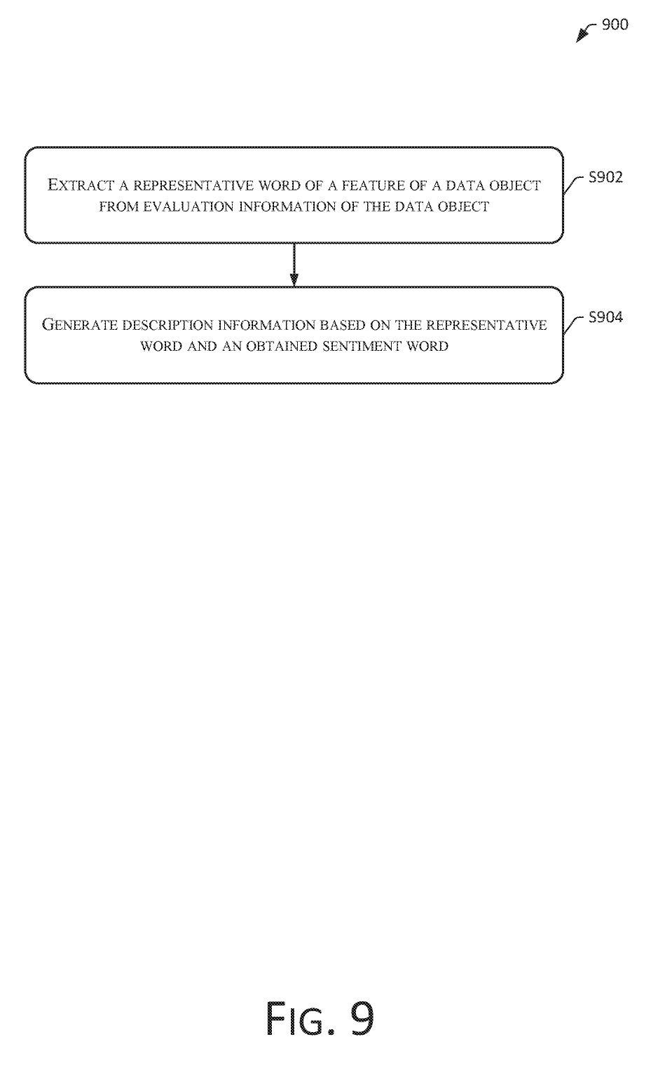

Referring to FIG. 9, the present application further provides a data object description information generation method 900. As shown in FIG. 9, the method 900 may include the following steps:

Step S902: a representative word of a feature of a data object is extracted from evaluation information of the data object.

Step S904: description information is generated based on the representative word and an obtained sentiment word.

In this example embodiment, the data object may be a product or service sold in a network platform. The data object may be a physical article, such as articles of daily use, computer consumables, foods, and electronic devices. The data object may also be a virtual commodity, such as game currency and household services.

In this example embodiment, the product or service may be sold through a network sales platform. The network sales platform may be, for example, Taobao™, Jingdong™, Amazon™, etc. Each network sales platform may correspond to an application respectively, and by using the application, a user may complete purchasing and evaluation on the product or service. The application may be, for example, a Taobao™ client terminal, a Tmall™ client terminal, a Jingdong™ client terminal, and the like running on a terminal device. The application may be provided with a comment area for each product or service. Comment information entered by a user who purchases the product or service may be presented in the comment area.

In this example embodiment, the comment information of the product or service may be stored in a background business server corresponding to the application. The comment information of the product or service may form a comment information set, and the comment information set includes at least one piece of evaluation information of the product or service.

In this example embodiment, the evaluation information generally evaluates a data object in terms of one or more aspects. For example, for a “one-piece dress”, users' evaluation information may evaluate collar, cuff, and skirt hemline of the one-piece dress. In this example embodiment, the feature of the data object may be an attribute of the data object. For example, the collar, the cuff, and the skirt hemline may be features of the one-piece dress.

It should be noted that, different users generally have different language habits, and therefore, words used by the users for describing a same attribute of the data object may be different. For example, for the attribute collar, features corresponding thereto may be collarband, collar, neckline, and the like. In this example embodiment, different features may be summarized in the finally generated description information to determine a representative word of the features. For example, a representative word corresponding to collarband, collar, and neckline may be collar. In this way, different representative words may be used to indicate different features of the data object.

In this example embodiment, the method of extracting the representative word of the feature of the data object may include: segmenting the evaluation information of the data object according to a semantic relationship, and matching obtained words with words in a preset lexicon, where words obtained by matching may be used as the representative word of the feature of the data object. In this example embodiment, the words in the preset lexicon may be generated according to a large amount of evaluation information, and each word may represent a feature of the data object.

In this example embodiment, when a user evaluates different features, the user may generally use some sentiment words to express appraising of a feature of the data object. For example, in the evaluation information “The skirt hemline of the one-piece dress is a very beautiful design”, the skirt hemline may be used as the feature of the one-piece dress, and “very beautiful” may be used as the sentiment word modifying the skirt hemline. In this example embodiment, after the representative word of the feature of the data object is determined, description information of the data object may be generated according to the determined representative word and the obtained sentiment word. For example, the representative words of the feature of the one-piece dress may include collar, cuff, and skirt hemline. Sentiment words respectively corresponding to these representative words may be too narrow, very nice, and very unique. In this way, according to the representative words and the corresponding sentiment words, such description information “the collar is too narrow, the cuff is very nice, and the skirt hemline is very unique” may be generated.

In an example embodiment of the present application, at least one current feature word set may be extracted from the evaluation information according to a preset lexicon. The preset lexicon has at least one feature word set preset therein, and each feature word set includes at least one feature word. Then, a representative feature word of each current feature word set may be determined respectively, and each determined representative feature word may be used as the representative word of the feature of the data object.

In this example embodiment, a feature word and a sentiment word associated with each other that are extracted from a same piece of evaluation information may form a word group. In this way, the evaluation information set may include a preset quantity of evaluation information. Therefore, a preset quantity of word groups may also be extracted from the evaluation information set.

In this example embodiment, words in the evaluation information may be matched by using words in the preset lexicon to extract feature words and sentiment words in the evaluation information. Specifically, the preset lexicon may include multiple feature words and sentiment words. The feature words and the sentiment words may be classified by a preset rule to form a feature word set and a sentiment word set. Feature words located in the same feature word set may have identical or similar meanings. For example, the feature words such as “collar”, “collarband”, and “neckline” may belong to the same feature word set. Sentiment words located in the same sentiment word set may have identical or similar meanings. For example, sentiment words expressing a positive sentiment such as “nice”, “unique”, and “good” may belong to a same sentiment word set. All sentiment words in the preset lexicon may also be located in a same sentiment word set to distinguish the sentiment words from the feature words.

In this example embodiment, the feature word in the word group is extracted from the comment information set according to the word in the preset lexicon. Therefore, the feature word in the word group may exist in the preset lexicon. In this way, the feature words in the preset quantity of word groups may belong to at least one current feature word set of the at least one feature word set. For example, the feature words in the preset quantity of word groups may be “collarband”, “collar”, “neckline”, “cuff”, “sleeve”, “skirt hemline”, and “hemline”. Therefore, the three feature words “collarband”, “collar”, and “neckline” may belong to the current feature word set representing the meaning of “collar”; “cuff” and “sleeve” may belong to the current feature word set representing the meaning of “cuff”; and “skirt hemline” and “hemline” may belong to the current feature word set representing the meaning of “skirt hemline”.

In the present application, each feature word set in the preset lexicon is respectively corresponding to at least one attribute of the data object. For example, the feature word set constructed by “collarband”, “collar”, and “neckline” may be corresponding to the collar attribute of the data object. The feature word set constructed by “cuff” and “sleeve” may be corresponding to the cuff attribute of the data object.

In an example embodiment of the present application, the preset lexicon may also be established according to the steps shown in FIG. 4. Specifically, first a corpus may be obtained, and word vectors of words in the corpus may be obtained according to a preset algorithm. Then, the words in the corpus are clustered according to the obtained word vectors, to obtain the preset lexicon including at least one feature word set, the feature word set including at least one feature word.

Please refer to the description of FIG. 4 for the example embodiment, which is not repeated herein.

In an example embodiment of the present application, when the feature word set in the preset lexicon is obtained by clustering word vectors, a representative feature word of the at least one current feature word set may be obtained by calculating a center word vector. Specifically, in this example embodiment, word vectors of the words in each current feature word set may be averaged to obtain a center word vector. For example, the current feature word set includes 5 words, and word vectors of the 5 words are respectively (a₁, b₁), (a₂, b₂) (a₃, b₃), (a₄, b₄), and (a₅, b₅). Then, corresponding elements in the 5 word vectors may be added and then divided by the number of the word vectors to obtain a center word vector.

After the center word vector is obtained through calculation, if the center word vector is just corresponding to a feature word in the current feature word set, the feature word corresponding to the center word vector may be determined as the representative feature word. However, the center word vector calculated through the above formula sometimes may not have a corresponding feature word in the current feature word set, and in this case, a feature word corresponding to a word vector closest to the center word vector may be determined as the representative feature word.

In an example embodiment of the present application, to enable description phrases in the generated description information to be more natural and closer to the real expression method of users, the description phrases may be generated by using a language organization method in the evaluation information. Specifically, the description phrases may be generated by using the method shown in FIG. 6. First, a target evaluation statement may be obtained from the evaluation information set, a feature word in the target evaluation statement belonging to a same word set as the representative feature word respectively. Then, the feature word in the target evaluation statement is replaced with the corresponding representative feature word respectively, and a sentiment word in the target evaluation statement may be replaced with a representative sentiment word corresponding to the corresponding representative feature word respectively, to generate the description information. Please refer to the above description of FIG. 6 for the example embodiment process, which is not repeated herein.

In an example embodiment of the present application, there may be multiple representative feature words corresponding to a same data object. For example, representative feature words corresponding to a one-piece dress may include “collar”, “cuff”, “skirt hemline”, “service attitude”, and “logistics”, and users may concern a unique feature of the one-piece dress, for example, “skirt hemline”, and “logistics” and “service attitude” may be less concerned. In this example embodiment, when the description information includes at least two description phrases, the description phrases may be sorted according to degrees of importance of representative feature words in the description phrases, and the feature more concerned by users is described preferentially. Specifically, in this example embodiment, a priority parameter of each representative feature word in the description information may be determined. The priority parameter may be calculated by using a mutual information algorithm or a TFIDF algorithm.

In this example embodiment, after the priority parameter corresponding to each representative feature word is calculated, the at least two description phrases in the description information may be sorted according to the determined priority parameter. For example, for the two representative feature words: skirt hemline and logistics of the one-piece dress, the skirt hemline may be described prior to the logistics.

Correspondingly, the present application further provides an electronic device. The electronic device may include a memory and a processor.

The memory may store evaluation information of a data object.

The processor may read the evaluation information of the data object from the memory, and extract a representative word of a feature of the data object from the evaluation information; and generate description information based on the representative word and an obtained sentiment word.

In this example embodiment, the memory may be a memory device configured to store information. In a digital system, a device capable of storing binary data may be a memory. In an integrated circuit, a circuit without a physical form but having a storage function may also be a memory, such as a RAM or a FIFO. In a system, a storage device having a physical form may also be referred to as a memory, such as a memory bank or a TF card.

In this example embodiment, the processor may be implemented in any suitable method. For example, the processor may be in the form of, for example, a microprocessor or a processor and a computer readable medium storing computer readable program codes (for example, software or firmware) executable by the (micro)processor, a logic gate, a switch, an Application Specific Integrated Circuit (ASIC), a programmable logic controller, an embedded micro-controller, and so on. This is not limited in the present application.

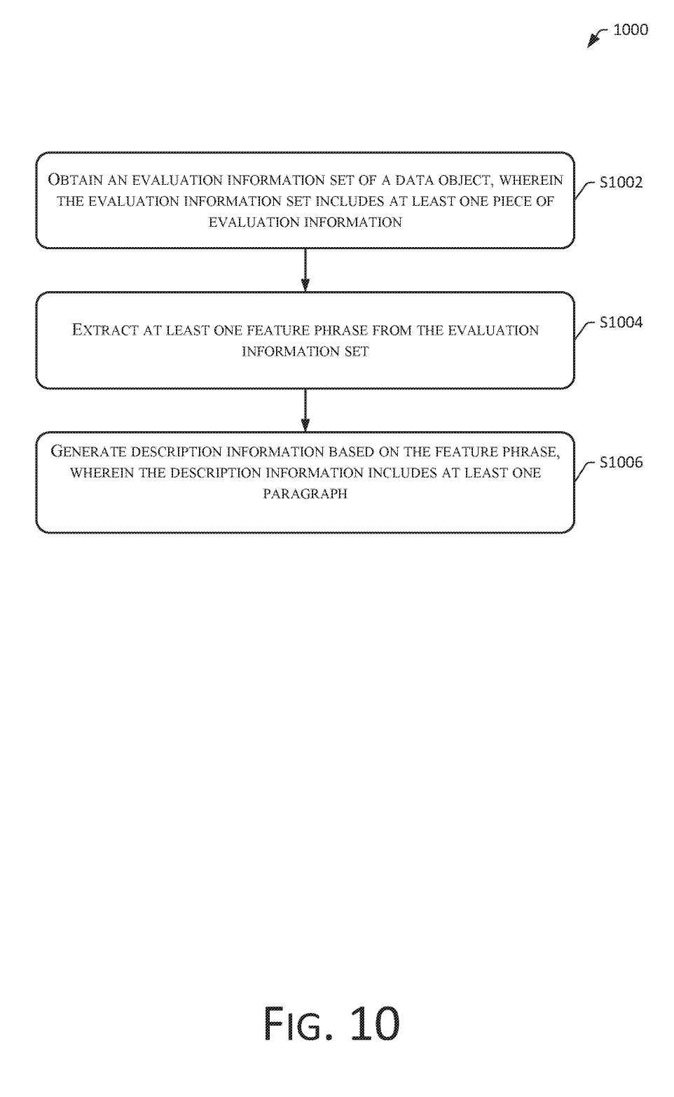

Referring to FIG. 10, the present application further provides a data object description information generation method 1000. As shown in FIG. 10, the method 1000 may include the following steps:

Step S1002: an evaluation information set of the data object is obtained, wherein the evaluation information set includes at least one piece of evaluation information.

Step S1004: at least one feature phrase is extracted from the evaluation information set.

Step S1006: description information is generated based on the feature phrase, wherein the description information includes at least one paragraph.

In this example embodiment, the evaluation information may evaluate a feature of a data object. The evaluation information may include a feature word for indicating a feature of the data object, and may further include a sentiment word for modifying the feature word. For example, in evaluation information “The skirt hemline of this one-piece dress is a beautiful design, and I like it very much”, skirt hemline may be used as the feature word, and beautiful may be used as the sentiment word for modifying the feature word.

In this example embodiment, the evaluation information is entered by the users. Language styles forming the evaluation information are generally different according to language habits of different users. A dispensable description statement may exist in the evaluation information. For example, for the evaluation information “The skirt hemline of this one-piece dress is a beautiful design, and I like it very much”, “this one-piece dress” therein may be omitted as it is located in an evaluation area of a one-piece dress product, and “I like it very much” expresses the experience of the user and may also be omitted in the description information describing the one-piece dress. Therefore, a piece of short evaluation information “the skirt hemline is beautiful” may be extracted from the evaluation information. In this example embodiment, the feature phrase may be compact evaluation information including a feature word and a sentiment word. The evaluation information such as the above “the skirt hemline is beautiful” may be used as the feature phrase.

In this example embodiment, after at least one feature phrase is extracted, description information may be generated based on the feature phrase. Wherein, the description information may include at least one paragraph. In this example embodiment, the paragraph may include a statement connected by punctuations. The paragraph may also be a statement ended in a designated method. Specifically, for example, “Enter” is used as an end. Generally, words in the last line of a paragraph occupy a line, and other words not belonging to the paragraph are located in a new line. Wherein, the statement may include at least one feature phrase. For example, feature phrases extracted for the one-piece dress product may include “the skirt hemline is so beautiful”, “the neckline is a little narrow”, and “the cuff is very unique”. Then, these feature phrases may be connected by punctuations to form description information. The description information may be “The skirt hemline is so beautiful, and the cuff is very unique, but the neckline is a little narrow.” The description information may be presented at a preset position (for example, above the comment area) of the comment area of the product. The description information may be presented by a paragraph.

In this example embodiment, the method of obtaining the evaluation information set of the data object may include: reading an evaluation information set of the data object from a storage medium storing the evaluation information set or receiving an evaluation information set of the data object sent by another device. Specifically, comment information sets of multiple data objects may be stored in the storage medium. Associated data object and comment information set may both carry a same identification. The identification may be, for example, a numerical symbol of the data object in the network sales platform. Through a designated identification, an evaluation information set of a product or service corresponding to the designated identification may be read from the storage medium. Moreover, the evaluation information set of the data object may be stored in another device. In this example embodiment, a data acquisition request may be sent to another device storing the evaluation information set of the data object. In this way, after receiving the data acquisition request, another device may send the evaluation information set of the data object, thereby obtaining the evaluation information set of the data object by data reception.

In an example embodiment of the present application, when at least one feature phrase is extracted from the evaluation information set, first a preset quantity of word groups may be extracted from the evaluation information set, the word group including a feature word and an associated sentiment word, wherein the feature word and the sentiment word associated with each other are located in a same piece of evaluation information. Then, the at least one feature phrase may be generated based on the preset quantity of word groups.

In this example embodiment, the feature word may be a word for describing a detail of the data object. For example, if the data object is a one-piece dress, the feature word may be “collar”, “cuff”, “waistline”, and the like. A sentiment word associated with the feature word may be a word for evaluating the detail, for example, “good”, “unique”, “bad”, or the like. For instance, in evaluation information “unique collar design”, “collar” may be the feature word, and “unique” may be the sentiment word associated with the feature word “collar”.

In this example embodiment, the association between the feature word and the sentiment word may be embodied in that: the feature word and the sentiment word associated with each other are located in a same piece of evaluation information. For example, in the evaluation information “unique collar design”, “collar” and “unique” are located in the same piece of evaluation information. Therefore, the feature word “collar” and the sentiment word “unique” extracted from the evaluation information are associated with each other. In another piece of evaluation information “the collar is ugly”, a feature word “collar” and a sentiment word “ugly” extracted therefrom are also associated with each other. It can be seen that, different sentiment words may be associated with a same feature word in the evaluation information set.

In this example embodiment, a feature word and a sentiment word associated with each other that are extracted from a same piece of evaluation information may form a word group. In this way, the evaluation information set may include a preset quantity of evaluation information. Therefore, a preset quantity of word groups may also be extracted from the evaluation information set.

In this example embodiment, the feature word and the sentiment word associated with each other may construct a phrase, and therefore, at least one feature phrase may be formed.

In an example embodiment of the present application, there may be multiple feature words corresponding to a same data object. For example, feature words corresponding to a one-piece dress may include “collar”, “cuff”, “skirt hemline”, “service attitude”, and “logistics”, and users may concern a unique feature of the one-piece dress, for example, “skirt hemline”, and “logistics” and “service attitude” may be less concerned. In this example embodiment, the feature phrases may be sorted according to degrees of importance of feature words in the feature phrases, and the feature more concerned by users is described preferentially. Specifically, in this example embodiment, a priority parameter of each feature word in the description information may be determined. The priority parameter may be calculated by using a mutual information algorithm or a TFIDF algorithm.

In this example embodiment, after the priority parameter corresponding to each feature word is calculated, the at least two feature phrases may be sorted according to the determined priority parameter, to generate the description information. For example, for the two feature words: skirt hemline and logistics of the one-piece dress, the feature phrase related to the skirt hemline may be described prior to the feature phrase related to the logistics.

Correspondingly, the present application further provides an electronic device. The electronic device may include: a memory and a processor.

The memory is configured to store an evaluation information set of a data object, wherein the evaluation information set includes at least one piece of evaluation information.

The processor is configured to read the evaluation information set from the memory; extract at least one feature phrase from the evaluation information set; and generate description information based on the feature phrase, wherein the description information includes at least one paragraph.

In this example embodiment, the memory may be a memory device configured to store information. In a digital system, a device capable of storing binary data may be a memory. In an integrated circuit, a circuit without a physical form but having a storage function may also be a memory, such as a RAM or a FIFO. In a system, a storage device having a physical form may also be referred to as a memory, such as a memory bank or a TF card.

In this example embodiment, the processor may be implemented in any suitable method. For example, the processor may be in the form of, for example, a microprocessor or a processor and a computer readable medium storing computer readable program codes (for example, software or firmware) executable by the (micro)processor, a logic gate, a switch, an Application Specific Integrated Circuit (ASIC), a programmable logic controller, an embedded micro-controller, and so on. This is not limited in the present application.

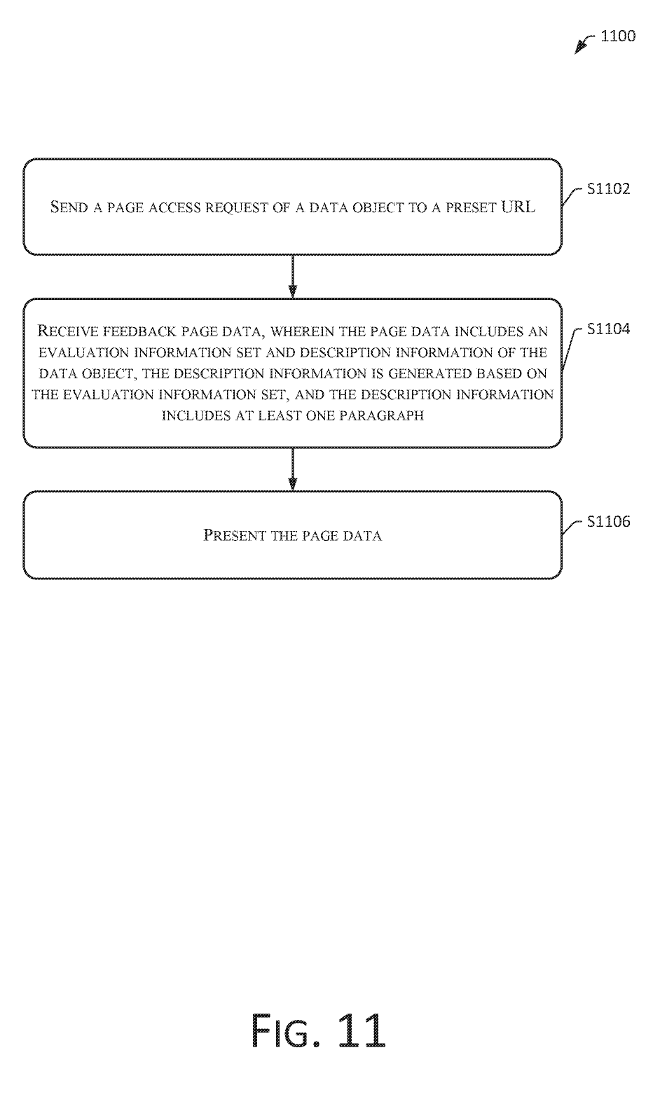

Referring to FIG. 11, an example embodiment of the present application may further provide a data object description information presentation method 1100 applied to a client terminal. As shown in FIG. 11, the method may include the following steps.

Step S1102: a page access request of the data object is sent to a preset URL.

Step S1104: feedback page data is received, wherein the page data includes an evaluation information set and description information of the data object, the description information is generated based on the evaluation information set, and the description information includes at least one paragraph.

Step S1106: the page data is presented.

In this example embodiment, the preset URL may be a corresponding URL of the data object in the server. When the client terminal needs to access a page of the data object, the client terminal may send a page access request to a corresponding URL of the data object in the server. The page access request may include an identification that can represent the data object. The identification may be, for example, a product number of the data object or a numerical symbol stored in the server.

In this example embodiment, after receiving the page access request sent by the client terminal, the server may process page data of the data object according to a preset rule, and feed back the page data of the data object to the client terminal upon completion of the process. In this example embodiment, the page data may include an evaluation information set and description information of the data object. The description information is generated based on the evaluation information set, and the description information includes at least one paragraph. The paragraph may include a statement connected by punctuations. The paragraph may also be a statement ended in a designated method. Specifically, for example, “Enter” is used as an end. Generally, words in the last line of a paragraph occupy a line, and other words not belonging to the paragraph are in a new line.

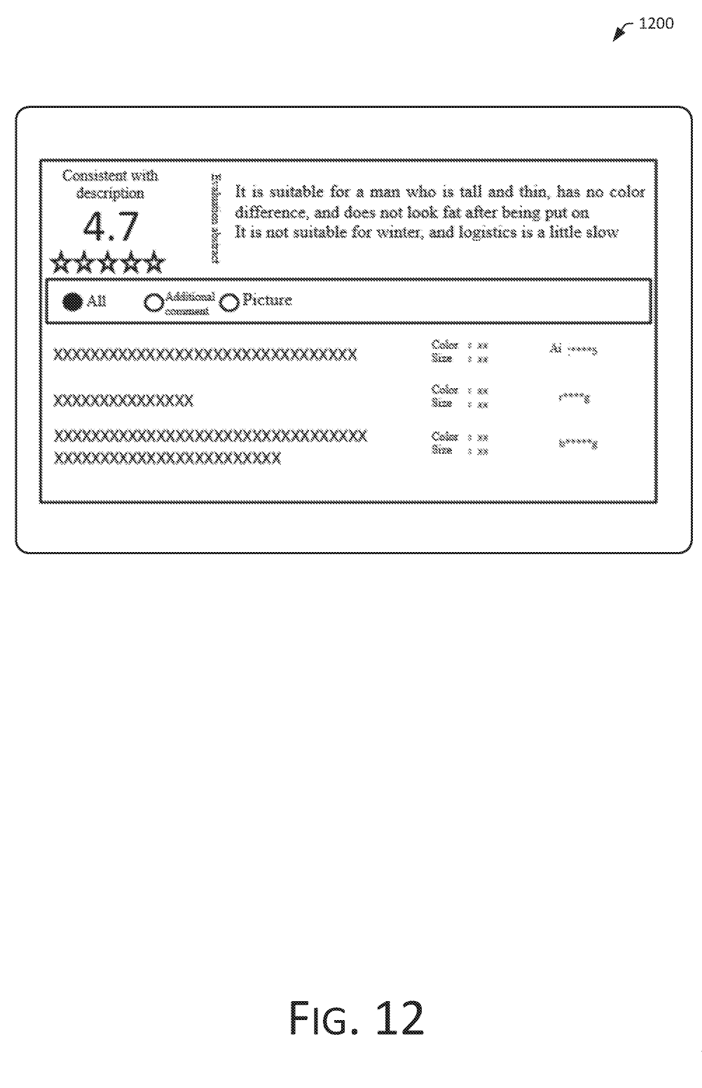

After receiving the page data fed back by the server, the client terminal may present the page data. FIG. 12 is a schematic diagram of the page data according to the present application. An evaluation page of the data object can be seen from FIG. 12. The page may include all evaluation information of users, colors and sizes selected by the users, and some characters of user accounts. Scores, grades and evaluation abstracts of the data object may be set above the evaluation information. In this example embodiment, the description information may be filled in the evaluation abstract. As shown in FIG. 12, the description information may be expressed by using two paragraphs, wherein content of one paragraph is “it is suitable for a man who is tall and thin, has no color difference, and does not look fat after being put on”, and content of the other paragraph is “it is not suitable for winter, and logistics is a little slow”. The two paragraphs may both be ended by using “Enter”.

In an example embodiment of the present application, the description information may be generated based on the evaluation information set. Specifically, at least one feature phrase may first be extracted from the evaluation information set. Then, description information may be generated based on the feature phrase. Specifically, the evaluation information may evaluate a feature of a data object. The evaluation information may include a feature word for indicating a feature of the data object, and may further include a sentiment word for modifying the feature word. For example, in evaluation information “The skirt hemline of this one-piece dress is a beautiful design, and I like it very much”, skirt hemline may be used as the feature word, and beautiful may be used as the sentiment word for modifying the feature word.

In this example embodiment, the feature phrase may be compact evaluation information including a feature word and a sentiment word. For example, for the evaluation information “The skirt hemline of this one-piece dress is a beautiful design, and I like it very much”, “this one-piece dress” therein may be omitted as it is located in an evaluation area of a one-piece dress product, and “I like it very much” expresses the experience of the user and may also be omitted in the description information describing the one-piece dress. Therefore, the feature phrase “the skirt hemline is beautiful” may be extracted from the evaluation information.

In this example embodiment, after the feature phrase is extracted, description information may be generated based on the feature phrase. Wherein, the description information may include at least one paragraph. In this example embodiment, the paragraph may include a statement connected by punctuations, wherein the statement may include at least one feature phrase. For example, feature phrases extracted for the one-piece dress product may include “the skirt hemline is so beautiful”, “the neckline is a little narrow”, and “the cuff is very unique”. Then, these feature phrases may be connected by punctuations to form description information. The description information may be “The skirt hemline is so beautiful, and the cuff is unique, but the neckline is a little narrow.” The description information may be presented at a preset position (for example, above the comment area) of the comment area of the product. The description information may be presented by a paragraph.

In an example embodiment of the present application, when at least one feature phrase is extracted from the evaluation information set, first a preset quantity of word groups may be extracted from the evaluation information set, the word group including a feature word and a sentiment word associated with each other, wherein the feature word and the sentiment word associated with each other are located in a same piece of evaluation information. Then, the at least one feature phrase may be generated based on the preset quantity of word groups.

In this example embodiment, the feature word may be a word for describing a detail of the data object. For example, if the data object is a one-piece dress, the feature word may be “collar”, “cuff”, “waistline”, and the like. A sentiment word associated with the feature word may be a word for evaluating the detail, for example, “good”, “unique”, “bad”, or the like. For instance, in evaluation information “unique collar design”, “collar” may be the feature word, and “unique” may be the sentiment word associated with the feature word “collar”.

In this example embodiment, the association between the feature word and the sentiment word may be embodied in that: the feature word and the sentiment word associated with each other are located in a same piece of evaluation information. For example, in the evaluation information “unique collar design”, “collar” and “unique” are located in the same piece of evaluation information. Therefore, the feature word “collar” and the sentiment word “unique” extracted from the evaluation information are associated with each other. In another piece of evaluation information “the collar is ugly”, a feature word “collar” and a sentiment word “ugly” extracted therefrom are also associated with each other. It can be seen that, different sentiment words may be associated with a same feature word in the evaluation information set.

In this example embodiment, a feature word and a sentiment word associated with each other that are extracted from a same piece of evaluation information may form a word group. In this way, the evaluation information set may include a preset quantity of evaluation information. Therefore, a preset quantity of word groups may also be extracted from the evaluation information set.

In this example embodiment, the feature word and the sentiment word associated with each other may construct a phrase, and therefore, at least one feature phrase may be formed.

In an example embodiment of the present application, there may be multiple feature words corresponding to a same data object. For example, feature words corresponding to a one-piece dress may include “collar”, “cuff”, “skirt hemline”, “service attitude”, and “logistics”, and users may concern a unique feature of the one-piece dress, for example, “skirt hemline”, and “logistics” and “service attitude” may be less concerned. In this example embodiment, the feature phrases may be sorted according to degrees of importance of feature words in the feature phrases, and the feature more concerned by users is described preferentially. Specifically, in this example embodiment, a priority parameter of each feature word in the description information may be determined. The priority parameter may be calculated by using a mutual information algorithm or a TFIDF algorithm.

In this example embodiment, after the priority parameter corresponding to each feature word is calculated, the at least two feature phrases may be sorted according to the determined priority parameter, to generate the description information. For example, for the two feature words: skirt hemline and logistics of the one-piece dress, the feature phrase related to the skirt hemline may be described prior to the feature phrase related to the logistics.

Correspondingly, the present application further provides an electronic device. The electronic device may include a network communication module, a processor, and a display screen.

The network communication module is configured to conduct network data communication.

The processor is configured to control the network communication module to send a page access request of a data object to a preset URL; control the network communication module to receive feedback page data, wherein the page data includes an evaluation information set and description information of the data object, the description information is generated based on the evaluation information set, and the description information includes at least one paragraph.

The display screen is configured to present the page data.

In this example embodiment, the network communication module can conduct network communication to receive and send data. The network communication module may be set according to a TCP/IP protocol, and may conduct network communication in the protocol frame. Specifically, it may be a wireless mobile network communication chip, such as a GSM or a CDMA. It may also be a Wifi chip or a Bluetooth chip.

In this example embodiment, the processor may be implemented in any suitable method. For example, the processor may be in the form of, for example, a microprocessor or a processor and a computer readable medium storing computer readable program codes (for example, software or firmware) executable by the (micro)processor, a logic gate, a switch, an Application Specific Integrated Circuit (ASIC), a programmable logic controller, an embedded micro-controller, and so on. This is not limited in the present application.

In this example embodiment, the display screen may be a display tool that displays certain electronic files on a screen through a specific transmission device and then reflects the electronic files to human eyes. The display screen may include a liquid crystal display (LCD) display screen, a cathode-ray tube (CRT) display screen, a light-emitting diode (LED) display screen, or the like.

It can be seen from the technical solutions provided in the example embodiments of the present application that, the present application extracts a feature word and a sentiment word associated with each other from evaluation information of a data object. The feature word may be a word for describing a detail of the data object, such as “collar” and “cuff”; and the sentiment word associated with the feature word may be a word for evaluating the detail, such as “good” and “unique”. The present application may determine a representative feature word for feature words describing a same detail, to implement unification of the feature words. For example, for the feature words such as “collar” and “neckline”, a corresponding representative feature word may be “collar”. Then, the present application may judge, according to a sentiment word describing the same detail, whether a user who has purchased the data object likes or dislikes the detail, thereby obtaining a representative sentiment word corresponding to the representative feature word. Therefore, description information for describing the detail of the data object may be generated according to the representative feature word and the corresponding representative sentiment word. Therefore, the description information generated with the technical solution of the present application can include a statement for describing the detail of the data object, thereby improving the accuracy of data object description.

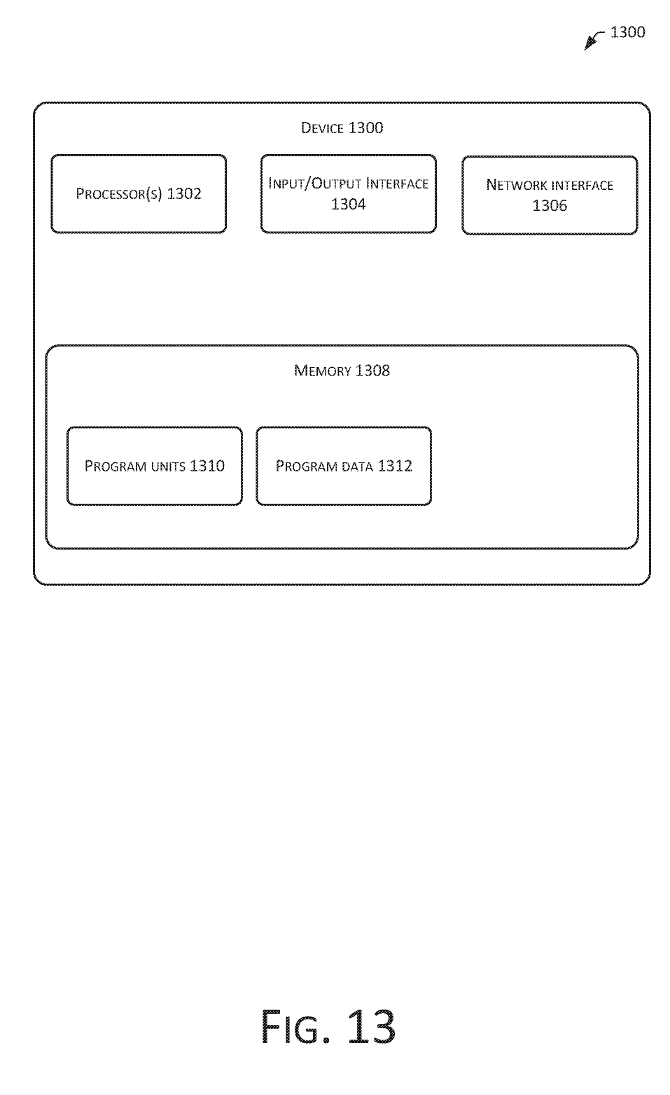

In a typical configuration, an electronic device includes one or more processors (CPUs), an input/output interface, a network interface, and a memory. FIG. 13 shows an example electronic device 1300, (e.g., any one of the devices described in the present application,). The device 1300 may include one or more processors 1302, an input/out interface 1304, a network interface 1306, and memory 1308.

The memory 1308 may include a volatile memory, a random access memory (RAM) and/or a non-volatile memory or the like in a computer readable medium, for example, a read-only memory (ROM) or a flash RAM. The memory 1308 is an example of the computer readable medium.

The computer readable medium includes non-volatile or volatile, and movable or non-movable media, and can implement information storage by means of any method or technology. Information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storages, a cassette tape, a magnetic tape/magnetic disk storage or other magnetic storage apparatus, or any other non-transmission medium, and can be used to store information accessible to the computing device. According to the definition in this text, the computer readable medium does not include transitory media, such as modulated data signals and carriers.

The memory 1308 may include program units 1310 and program data 1312. Depending on which device (e.g., any one of the devices described in the present application), the program units 1310 may include one or more of the foregoing units as described in the corresponding apparatus.

Persons skilled in the art should understand that, the example embodiments of the present application may be provided as a method, a system, or a computer program product. Therefore, the present application may be in the form of a complete hardware example embodiment, a complete software example embodiment, or an example embodiment combining software and hardware. Moreover, the present application may employ the form of a computer program product implemented on one or more computer usable storage media (including, but not limited to, a magnetic disk memory, a CD-ROM, an optical memory, and the like) including computer usable program code.

In this specification, adjectives such as first and second may only be used to distinguish one element or action from another element or action, and do not necessarily require or imply any actual relationship or order. If an environment allows, a reference element or member or step (etc.) should not be construed as being limited to only one of the elements, members, or steps, but may be one or more of the elements, members, or steps.

The descriptions of various example embodiments in the present application are provided for those skilled in the art with the purpose of description. They are neither intended to be exhaustive, nor intended to limit the present application to a single disclosed example embodiment. As described above, various replacements and variations of the present application are apparent for those skilled in the art. Therefore, although some optional example embodiments have been discussed specifically, other example embodiments will be apparent or be easily derived by those skilled in the art. The present application aims to include all replacements, modifications, and variations of the present application that have been discussed, and other example embodiments falling within the spirit and scope of the present application.

For ease of description, when the apparatus is described, it is divided into various units in terms of functions for respective descriptions. When the present application is implemented, functions of the units may be implemented in one or more software and/or hardware.

Various example embodiments in the specification are described in a progressive method. The same or similar parts between the example embodiments may be referenced to one another. In each example embodiment, differences between the example embodiment and other example embodiments are focused and described. Especially, the apparatus example embodiment is basically similar to the method example embodiment, so that it is described simply. For related parts, refer to the descriptions of the parts in the method example embodiment.

The present application is applicable to various universal or dedicated computer system environments or configurations, such as, a personal computer, a server computer, a handheld device or a portable device, a tablet device, a multi-processor system, a microprocessor-based system, a set top box, a programmable consumer electronic device, a network PC, a microcomputer, a mainframe computer, and a distributed computing environment including any of the above systems or devices.

The present application may be described in a common context of a computer executable instruction performed by a computer, for example, a program module. Generally, the program module includes a routine, a program, an object, a component, a data structure, and the like for executing a specific task or implementing a specific abstract data type. The present application may also be implemented in distributed computing environments. In the distributed computing environments, a task is performed by using remote processing devices connected through a communications network. In the distributed computing environments, the program module may be in a local and remote computer storage medium including a storage device.

Although the present application is described through example embodiments, those of ordinary skill in the art should know that the present application has many variations and changes without departing from the spirit of the present application, and it is expected that the appended claims cover the variations and changes without departing from the spirit of the present application.

What is claimed is:

1. An information generation method, comprising:
obtaining an evaluation information set of a data object;
extracting at least one current feature word set and at least one current sentiment word set from the evaluation information set;
determining a representative feature word for each current feature word set respectively;
determining a representative sentiment word from a corresponding current sentiment word set, wherein the representative sentiment word corresponding to each representative feature word; and
generating description information based on at least one representative feature word and a respective corresponding representative sentiment word.

2. The method of claim 1, wherein the extracting at least one feature word set comprises: extracting at least one feature word set from the evaluation information set according to a preset lexicon, wherein the preset lexicon comprises at least one feature word set preset therein, and each feature word set comprises at least one feature word.

3. The method of claim 2, wherein the preset lexicon further comprises at least one sentiment word set pre-recorded therein; each sentiment word set comprises at least one sentiment word; and
wherein the extracting at least one current feature word set and at least one current sentiment word set further comprises: extracting at least one current sentiment word set from the evaluation information set according to the preset lexicon.

4. The method of claim 2, wherein the preset lexicon is established by the following steps:
obtaining a corpus; and
obtaining word vectors of words in the corpus according to a preset algorithm; and
clustering the words in the corpus according to the obtained word vectors to obtain the preset lexicon comprising at least one feature word set.

5. The method of claim 1, wherein the extracting at least one feature word set and at least one sentiment word set from the evaluation information set comprises:
extracting at least one current feature word set and at least one current sentiment word set from the evaluation information set through semantic analysis.

6. The method of claim 1, wherein the current feature word set comprises at least one feature word, the current sentiment word set comprises at least one sentiment word, and each feature word is capable of being associated with at least one sentiment word.

7. The method of claim 6, wherein the feature word and the sentiment word associated with each other are in the same piece of evaluation information, and the sentiment word has a modification relationship with the feature word.

8. The method of claim 2, wherein the determining a representative feature word of each current feature word set comprises:
obtaining a center word vector in each current feature word set; and
determining the representative feature word according to the center word vector in each current feature word set.

9. The method of claim 6, wherein the determining a representative feature word of each current feature word set comprises:
conducting statistics on the number of times each feature word in each current feature word set is matched in the evaluation information set; and
determining the representative feature word according to the statistics.

10. The method of claim 6, wherein the determining a representative sentiment word comprises:
conducting statistics on the number of times a sentiment word associated with a feature word in each current feature word set is repeated; and
using a sentiment word having the maximum number of repetition times as the representative sentiment word corresponding to each said representative feature word.

11. The method of claim 6, wherein categories of the sentiment words comprise a positive sentiment category and a negative sentiment category;
correspondingly, wherein the determining a representative sentiment word corresponding to each representative feature word comprises:
conducting statistics on a first quantity of sentiment words belonging to the positive sentiment category and a second quantity of sentiment words belonging to the negative sentiment category in sentiment words associated with the feature words in each current feature word set;
calculating a proportion of the first quantity in a sum of the first quantity and the second quantity; and
obtaining a sentiment degree word corresponding to the calculated proportion according to a preset mapping relationship; and
designating the sentiment degree word as the representative sentiment word corresponding to the representative feature word.

12. The method of claim 6, wherein categories of the sentiment words comprise a positive sentiment category and a negative sentiment category;
correspondingly, wherein the determining a representative sentiment word corresponding to each representative feature word comprises:
conducting statistics on a third quantity of sentiment words whose sentiment category is the positive sentiment category and a fourth quantity of sentiment words whose sentiment category is the negative sentiment category in sentiment words associated with the feature words in each current feature word set; and
determining a current sentiment word set corresponding to each current feature word set respectively by comparing the third quantity with the fourth quantity; and
obtaining a representative sentiment word corresponding to the representative feature word according to the current sentiment word set.

13. The method of claim 12, wherein when the third quantity is greater than the fourth quantity, the positive sentiment word set is determined as the current sentiment word set, and a representative sentiment word corresponding to the current sentiment word set is determined as the representative sentiment word corresponding to the representative feature word.

14. The method of claim 12, wherein when the third quantity is less than the fourth quantity, the negative sentiment word set is determined as the current sentiment word set, and a representative sentiment word corresponding to the current sentiment word set is determined as the representative sentiment word corresponding to the representative feature word.

15. The method of claim 5, wherein the determining a representative sentiment word comprises:
conducting statistics on a quantity of sentiment words belonging to a same sentiment word set in sentiment words associated with the feature words in each current feature word set;
using a sentiment word set having the maximum quantity as a current sentiment word set corresponding to the representative feature word; and
obtaining a representative sentiment word corresponding to each representative feature word respectively according to the current sentiment word set.

16. The method of claim 15, wherein the obtaining a representative sentiment word corresponding to each representative feature word comprises:
obtaining a center word vector in each current sentiment word set; and
determining a representative sentiment word corresponding to the current sentiment word set according to the center word vector.

17. The method of claim 5, wherein the generating description information comprises:
obtaining a target evaluation statement from the evaluation information set;
obtaining a feature word in the target evaluation statement belonging to a same word set as the representative feature word respectively; and
generating the description information by:
replacing the feature word in the target evaluation statement with the corresponding representative feature word respectively, and
replacing a sentiment word in the target evaluation statement with a representative sentiment word corresponding to the corresponding representative feature word respectively.

18. The method of claim 2, wherein the description information comprises at least two description phrases, and correspondingly, the method further comprises:
determining a priority parameter of each said representative feature word in the description information; and
sorting the at least two description phrases in the description information according to the determined priority parameter.

19. An information presentation system, comprising:
a server containing one or more memories having instructions which when executed cause one or more processors to perform acts including:
obtaining an evaluation information set of a data object;
extracting at least one current feature word set and at least one current sentiment word set from the evaluation information set, wherein the current feature word set comprises at least one feature word, the current sentiment word set comprises at least one sentiment word, and each said feature word is capable of being associated with at least one sentiment word;
determining a representative feature word of each current feature word set respectively;
determining a representative sentiment word corresponding to each representative feature word respectively according to a sentiment word associated with a feature word in each current feature word set;
generating description information based on at least one said representative feature word and a respective corresponding representative sentiment word; and
sending the description information to the client terminal.

20. An apparatus comprising:
one or more processors; and
one or more memories stored thereon computer readable instructions that, when executed by one or more processors, cause the one or more processors to perform acts comprising:
extracting at least one current feature word set and at least one current sentiment word set from the evaluation information set, wherein the current feature word set comprises at least one feature word, the current sentiment word set comprises at least one sentiment word, and each feature word is capable of being associated with at least one sentiment word;
determining a representative feature word of each current feature word set respectively;
determining a representative sentiment word corresponding to each representative feature word respectively according to a sentiment word associated with a feature word in each current feature word set; and
generating description information based on at least one representative feature word and a respective corresponding representative sentiment word.
